(19) United States
(12) Patent Application Publication
(10) Pub. No.: US 2022/0390731 A1
(43) Pub. Date: Dec. 8, 2022

(54) METHOD AND APPARATUS FOR ILLUMINATING A DEFINED AREA OF AN OBJECT

(71) Applicant: IDEXX Laboratories, Inc., Westbrook, ME (US)

(72) Inventor: Garland Christian Misener, Portland, ME (US)

(21) Appl. No.: 17/830,855

(22) Filed: Jun. 2, 2022

Related U.S. Application Data
(60) Provisional application No. 63/196,941, filed on Jun. 4, 2021.

(51) Int. Cl. G02B 21/10; G02B 21/16; G01N 21/64

(52) U.S. Cl. CPC G02B 21/10; G02B 21/16; G01N 21/6458

(57) ABSTRACT

An optical imaging system includes a light source, a light detector and an aperture plate. The light source includes a plurality of light emitting devices which emit light that is directed toward an object to be illuminated. The light detector is positioned to view the object illuminated by the light source. The aperture plate is positioned relative to the light source to block a first portion of the light emitted by the light source and to allow a second portion of the light emitted by the light source to pass therethrough to illuminate a pre-defined area of the object. The aperture plate includes a plurality of spaced apart apertures formed through the thickness thereof. Each aperture corresponds to a respective light emitting device. Each aperture of the aperture plate is defined by a first opening formed in the thickness of the aperture plate and a second opening formed in the thickness of the aperture plate. The second opening partially overlaps the first opening and is partially offset from the first opening. The first and second openings' planar shapes match the shape of the desired illumination area, with the first openings being smaller than the second openings. A method for illuminating a defined area of an object includes the steps of energizing one or more light emitting devices of a light source in an optical imaging system, which energized light emitting device or devices emit light that is directed toward the object to be illuminated. The light is passed through particularly-shaped apertures, such as described above, formed in an aperture plate positioned between the light source and the object to be illuminated. The apertures in the plate only allow light passing therethrough to impinge on the object at a pre-defined area thereof.

### CROSS-REFERENCE TO RELATED APPLICATIONS

This application is related to U.S. Provisional Patent Application Ser. No. 63/196,941, filed on Jun. 4, 2021, and titled “Method And Apparatus For Illuminating A Defined Area Of An Object”, the disclosure of which is hereby incorporated by reference and on which priority is hereby claimed.

### BACKGROUND OF THE INVENTION

### Field of the Invention

The present invention generally relates to optical imaging systems and methods used, for example, in chemical analyzers and component or sample inspection apparatus and instruments, and more particularly relates to methods and techniques, and components of an optical imaging system, that are used in illuminating and imaging an object for inspection or analysis.

### Description of the Related Art

In compact, inexpensive optical imaging systems, light-emitting diode (LED) illumination can be very effective due to its relatively low cost and its per-LED intensity control and wavelength specification capabilities. Another advantage is that multiple LEDs can be arranged around the sample to illuminate it at acute or obtuse angles relative to the detection optical axis. Thus, bright field configurations (for sample absorbance or transmission detection) and epifluorescence configurations (for fluorescence sample detection) can be avoided for cases where dark field acute or obtuse illumination is advantageous.

For example, the commonly-applied epifluorescence configuration typically requires three dielectric filters for low limit-of-detection applications—two bandpass and one dichroic mirror. All three are typically needed to reduce irradiation of the detector by the radiant energy used for fluorescence excitation. An acute or obtuse illumination angle, such as at roughly 45 degrees or 135 degrees, respectively, will strongly reduce the specular reflection toward the detector from any surfaces associated with the sample that are oriented perpendicularly or parallelly to the detection optical axis. In this case, an excitation filter may not be needed at all, or a much less expensive absorptive filter or combination of absorptive filters may be substituted. Furthermore, and again in this case, the functions of the dichroic mirror and the bandpass filter may be combined into one component. The specularly reflective surfaces associated with the sample may be, for example, microscope slides or coverslips, microtiter plate wells, or other substantially flat-bottomed and/or flat-topped sample containers.

U.S. Pat. No. 7,616,317, which issued on Nov. 10, 2009, and which titled “Reflectometer and Associated Light Source for Use in a Chemical Analyzer”, the disclosure of which is incorporated herein by reference, describes how a multi-LED light source can be configured to provide a substantially homogeneous irradiance at the illumination plane of a nearby object, even when only a few LEDs are energized to emit light.

The disclosure herein of the present invention illustrates another advantage of a source comprised of multiple, arranged LEDs. The illumination or detection fields, or both, can be made very “flat,” optically—an important advantage for quantitative analyses in which the detected fluorescent or scattered intensity per small component or area is meaningful.

### OBJECTS AND SUMMARY OF THE INVENTION

It is an object of the present invention to provide a method and apparatus for illuminating a defined area of an object.

It is another object of the present invention to provide an optical imaging system that provides a controlled illumination of a liquid sample contained within a well or other form of container or deposited on a test slide.

It is still another object of the present invention to provide an aperture plate for use in an optical imaging system which controls the obscuration and/or permits the transmission of rays of light emitted by a light source of the imaging system.

It is a further object of the present invention to provide a method for designing an aperture plate for use in an optical imaging system so that the optical imaging system can controllably illuminate a defined area of an object.

It is yet a further object of the present invention to provide an optical imaging system for use in a chemical analyzer or component or sample inspection apparatus or instrument which overcomes the inherent disadvantages of known optical imaging systems used in such analyzers, apparatus and instruments.

An optical imaging system constructed in accordance with one form of the present invention includes a light source, a light detector and an aperture plate. The light source includes a plurality of energizable light emitting devices which, when energized, emit light that is directed toward an object to be illuminated. The light detector, such as a camera, is positioned to be in optical communication with the object illuminated by the light source. The aperture plate is positioned relative to the light source to block a first portion of the light emitted by the light source and to allow a second portion of the light emitted by the light source to pass therethrough to illuminate a pre-defined area of the object.

The aperture plate includes a plurality of spaced apart apertures formed through the thickness thereof. Each aperture of the plurality of apertures corresponds to a respective light emitting device of the plurality of light emitting devices.

Furthermore, each aperture of the plurality of apertures of the aperture plate is defined by a first opening formed in the thickness of the aperture plate and a second opening formed in the thickness of the aperture plate. The second opening partially overlaps the first opening and is partially offset from the first opening. The first opening has at least one first dimension, and the second opening has at least one second dimension. The at least one second dimension of the second opening is different from the at least one first dimension of the first opening.

A method for illuminating a defined area of an object in accordance with the present invention is also disclosed herein. The method includes the step of energizing one or more light emitting devices of a light source in an optical imaging system, which energized light emitting device or devices emit light that is directed toward the object to be illuminated. The light is passed through particularly-shaped apertures formed through the thickness of an aperture plate positioned between the light source and the object to be illuminated. Each aperture of the aperture plate is defined by a first opening formed in the thickness of the aperture plate and a second opening formed in the thickness of the aperture plate. The second opening partially overlaps the first opening and is partially offset from the first opening. The first opening has at least one first dimension, and the second opening has at least one second dimension, where the at least one second dimension of the second opening is different from the at least one first dimension of the first opening. Each of the first and second openings which define respective apertures in the aperture plate may be shaped as circles or rectangles, or may take on other planar shapes. The particular shape of the apertures, defined by the overlapping first openings and second openings, provides the aperture plate with the ability to block a first portion of the light emitted by the light source and to allow a second portion of the light emitted by the light source to pass therethrough to illuminate a defined area of the object.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a perspective view of an optical imaging system and one well of a microtiter plate, containing a liquid sample to be analyzed, and illustrating computer-generated rays of light emanating from a single LED (light emitting diode) of a light source of the optical imaging system containing multiple LEDs, the light rays being shown impinging on the well of the microtiter plate.

FIG. 2 is an enlarged perspective view of a portion of the well of the transparent microtiter plate of FIG. 1, and illustrating in greater detail a number of the computer-generated light rays shown in FIG. 1 impinging on the well of the microtiter plate.

FIG. 3 is a perspective view of the source of an optical imaging system and multiple wells of a microtiter plate, containing liquid samples to be analyzed, and illustrating computer-generated rays of light emanating from multiple LEDs (light emitting diodes) of the light source of the optical imaging system, the light rays being shown impinging on the wells of the microtiter plate. The detection system (objective and other lenses and imaging device) are not shown in this figure. The detection system would be located below the light source or above the microtiter plate, in either case with its optical axis coincident with the cylindrical optical axis of the light source, such as shown in FIG. 1.

FIG. 4 is an optical, transverse cross-sectional image of the wells of the microtiter plate shown in FIG. 3 taken along a plane parallel with the bottoms of the wells, and showing the illumination of the wells when multiple LEDs (light emitting diodes) of a light source of the optical imaging system are energized, such as illustrated by FIG. 3, the image including position coordinates and a scale of relative illumination (incoherent irradiance).

FIG. 5 is an enlarged, optical, transverse cross-sectional image of the centered well of the microtiter plate shown in FIG. 4 taken along the same plane parallel with the bottoms of the wells as in FIG. 4, and showing the illumination of the centered well when multiple LEDs (light emitting diodes) of a light source of the optical imaging system are energized, such as illustrated by FIG. 3, and illustrating a transverse cross-sectional region of the well depicted by a rectangular box superimposed on the image to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 6 is the same enlarged, optical, transverse cross-sectional image of the center well of the microtiter plate as shown in FIG. 5, but offset downward and slightly to the right, and illustrating the same transverse cross-sectional region of the well depicted by the rectangular box superimposed on the image as shown in FIG. 5. Due to the offset, the box is positioned in a different, second position relative to the well than that of the region depicted in FIG. 5 to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 7 is the same enlarged, optical, transverse cross-sectional image of the center well of the microtiter plate as shown in FIG. 5, but offset downward, and illustrating the same transverse cross-sectional region of the well depicted by the rectangular box superimposed on the image as shown in FIGS. 5 and 6. Due to the offset, the box is positioned in a different, third position relative to the well than that of the regions depicted in FIGS. 5 and 6 to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 8 is a top plan view of a first embodiment of an aperture plate formed in accordance with the present invention.

FIG. 8A is a diagrammatic view of one aperture of several apertures formed in the aperture plate of the present invention shown in FIG. 8, and illustrating the design considerations in the formation of the aperture plate and the apertures thereof. The two shaded portions of the circles represent substantially overlapping through holes, with example hole and bolt circle location radii. Also indicated are two extra cutouts (labeled A and B), both connecting the two holes by a line segment tangent to each hole's radii. For each aperture of the several apertures formed in the aperture plate, both holes and, if applied, the tangent cutouts extend perpendicularly through the entire thickness of the aperture plate.

FIG. 8B is a side elevational view of an optical imaging system (shown without the detection system), including the aperture plate shown in FIG. 8, formed in accordance with the present invention, and a well of a microtiter plate, and illustrating the position of the aperture plate relative to the light source of the optical imaging system and microtiter plate well.

FIG. 8C is a diagrammatic illustration showing the placement of the openings defining the apertures formed in the aperture plate of the present invention shown in FIG. 8.

FIG. 9 is a perspective view of the optical imaging system and aperture plate of the present invention shown in FIG. 8 and one well of a microtiter plate, containing a liquid sample to be analyzed, and illustrating the same computer-generated rays of light that are shown in FIG. 1 emanating from the single LED (light emitting diode) of the light source of the optical imaging system, where certain light rays are blocked by the aperture plate while other light rays pass through an aperture of the aperture plate and impinge on a defined area of the well of the microtiter plate. The detection system (objective and other lenses and imaging device) is located above the microtiter plate, with its optical axis coincident with the cylindrical optical axis of the light source.

FIG. 10 is an enlarged perspective view of a portion of the well of the transparent microtiter plate of FIG. 9, and illustrating in greater detail the same computer-generated light rays shown in FIG. 9 emanating from the single LED (light emitting diode) of the light source of the optical imaging system and impinging on the well of the microtiter plate. Other rays emanating from the single LED and shown in FIG. 9 are blocked from impinging on the well of the microtiter plate by the aperture plate.

FIG. 11 is the same enlarged perspective view of a portion of the well of the transparent microtiter plate as shown in FIG. 9, and illustrating in greater detail the same computer-generated light rays emanating from the single LED (light emitting diode) of the light source of the optical imaging system of the present invention and impinging on the well of the microtiter plate when the microtiter plate is moved in the same plane a first predetermined distance from its position shown in FIG. 10 to be in a second position and the aperture plate is moved in the same plane from its position which caused the illumination of the region of the microtiter well shown in FIG. 10 and in the same direction a distance that is proportional to the first distance that the microtiter plate is moved. Other rays emanating from the single LED and shown in FIG. 9 are blocked from impinging on the well of the microtiter plate by the aperture plate.

FIG. 12 is the same enlarged perspective view of a portion of the well of the transparent microtiter plate as shown in FIG. 9, and illustrating in greater detail the same computer-generated light rays emanating from the single LED (light emitting diode) of the light source of the optical imaging system of the present invention and impinging on the well of the microtiter plate when the microtiter plate is moved in the same plane a second predetermined distance from its position shown in FIG. 10 to be in a third position and the aperture plate is moved in the same plane from its position which caused the illumination of the region of the microtiter well shown in FIG. 10 and in the same direction a distance that is proportional to the second distance that the microtiter plate is moved. Other rays emanating from the single LED and shown in FIG. 9 are blocked from impinging on the well of the microtiter plate by the aperture plate.

FIG. 13 is an optical, transverse cross-sectional image of the wells of the microtiter plate similar to the image shown in FIG. 4 taken along a plane parallel with the bottoms of the wells, and showing the illumination of the wells when multiple LEDs (light emitting diodes) of a light source of the optical imaging system of the present invention shown in FIG. 9 are energized, such as illustrated by FIG. 3, the image including position coordinates and a scale of relative illumination (incoherent irradiance).

FIG. 14 is an enlarged, optical, transverse cross-sectional image of the centered well of the microtiter plate similar to the image shown in FIG. 5, and showing the illumination of the centered well when multiple LEDs (light emitting diodes) of a light source of the optical imaging system of the present invention shown in FIG. 9 are energized, such as illustrated by FIG. 3, and illustrating a transverse cross-sectional region of the well depicted by a rectangular box superimposed on the image, in same relative location as that shown in FIG. 5, to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 15 is an enlarged, optical, transverse cross-sectional image of the centered well of the microtiter plate similar to the image shown in FIG. 6, and showing the illumination of the centered well when multiple LEDs (light emitting diodes) of a light source of the optical imaging system of the present invention shown in FIG. 9 are energized, such as illustrated by FIG. 3, and illustrating a transverse cross-sectional region of the well depicted by a rectangular box superimposed on the image, in same relative location as that shown in FIG. 6, to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 16 is an enlarged, optical, transverse cross-sectional image of the centered well of the microtiter plate similar to the image shown in FIG. 7, and showing the illumination of the centered well when multiple LEDs (light emitting diodes) of a light source of the optical imaging system of the present invention shown in FIG. 9 are energized, such as illustrated by FIG. 3, and illustrating a transverse cross-sectional region of the well depicted by a rectangular box superimposed on the image, in same relative location as that shown in FIG. 7, to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 17 is a top plan view of a second embodiment of an aperture plate formed in accordance with the present invention.

FIG. 17A is a perspective view of an optical imaging system, including the aperture plate shown in FIG. 17, formed in accordance with the present invention, and a well of a microtiter plate, and illustrating the position of the aperture plate relative to other components of the optical imaging system and microtiter plate well. The detection system (objective and other lenses and imaging device) is located below the light source, with its optical axis coincident with the cylindrical optical axis of the light source.

FIG. 17B is a diagrammatic view of one aperture of several apertures formed in the aperture plate of the present invention shown in FIG. 17, and illustrating the design considerations in the formation of the aperture plate and the apertures thereof. FIG. 17B is identical to FIG. 8A except for the added large, centered detection opening, indicated (as the other two holes) by shading. For each aperture of the several apertures formed in the aperture plate, the first and second openings, the tangent cutouts (if applied), and the central detection opening extend perpendicularly through the entire thickness of the aperture plate.

FIG. 18 is an enlarged, optical, transverse cross-sectional image of the centered well of the microtiter plate similar to the image shown in FIG. 14, and showing the illumination of the centered well when multiple LEDs (light emitting diodes) of a light source of the optical imaging system and aperture plate of the present invention respectively shown in FIGS. 3 and 17 are energized, such as illustrated by FIG. 3, and illustrating a transverse cross-sectional region of the well depicted by a rectangular box superimposed on the image, in same relative location as that shown in FIG. 14, to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 19 is an enlarged, optical, transverse cross-sectional image of the centered well of the microtiter plate similar to the image shown in FIG. 15, and showing the illumination of the centered well when multiple LEDs (light emitting diodes) of a light source of the optical imaging system and aperture plate of the present invention respectively shown in FIGS. 3 and 17 are energized, such as illustrated by FIG. 3, and illustrating a transverse cross-sectional region of the well depicted by a rectangular box superimposed on the image, in same relative location as that shown in FIG. 15, to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 20 is an enlarged, optical, transverse cross-sectional image of the centered well of the microtiter plate similar to the image shown in FIG. 16, and showing the illumination of the centered well when multiple LEDs (light emitting diodes) of a light source of the optical imaging system and aperture plate of the present invention respectively shown in FIGS. 3 and 17 are energized, such as illustrated by FIG. 3, and illustrating a transverse cross-sectional region of the well depicted by a rectangular box superimposed on the image, in same relative location as that shown in FIG. 16, to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 21A is a top plan view of a third embodiment of an aperture plate formed in accordance with the present invention. In this case, the radius of the aperture is large enough to ensure that none of the rays from any of the LEDs are blocked from impinging on the bottom of a centered, target well of the microtiter plate.

FIG. 21 is an enlarged, optical, transverse cross-sectional image of the centered well of the microtiter plate similar to the image shown in FIG. 18, and showing the illumination of the centered well when multiple LEDs (light emitting diodes) of a light source of the optical imaging system and aperture plate of the present invention respectively shown in FIGS. 3 and 21A are energized, and illustrating a transverse cross-sectional region of the well depicted by a rectangular box superimposed on the image, in same relative location as that shown in FIG. 18, to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 22A is a top plan view of a fourth embodiment of an aperture plate formed in accordance with the present invention. In this case, the radius of the aperture is just large enough to ensure that none of the rays from the field of view of the object being imaged are vignetted by the aperture for an example, selected microscope objective.

FIG. 22 is an enlarged, optical, transverse cross-sectional image of the centered well of the microtiter plate similar to the image shown in FIG. 21, and showing the illumination of the centered well when multiple LEDs (light emitting diodes) of a light source of the optical imaging system and aperture plate of the present invention respectively shown in FIGS. 3 and 22A are energized, and illustrating a transverse cross-sectional region of the well depicted by a rectangular box superimposed on the image, in same relative location as that shown in FIG. 21, to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 23 is a top plan view of a fifth embodiment of an aperture plate formed in accordance with the present invention.

FIG. 23A is a diagrammatic view of one aperture of several apertures formed in the aperture plate of the present invention shown in FIG. 23, and illustrating the design considerations in the formation of the aperture plate and the apertures thereof. The two shaded rectangles represent substantially overlapping through holes, with example hole dimensions and bolt circle location radii. Also indicated are two extra cutouts (labeled C and D), both connecting the two holes by a line segment between corresponding corners of the two holes, where this connection occurs outside of the included area of both holes. For each aperture of the several apertures formed in the aperture plate, both openings and tangent cutouts extend perpendicularly through the entire thickness of the aperture plate.

FIG. 24 is an enlarged, optical, transverse cross-sectional image of the centered well of the microtiter plate similar to the image shown in FIG. 14, and showing the illumination of the centered well when multiple LEDs (light emitting diodes) of a light source of the optical imaging system and aperture plate of the present invention respectively shown in FIGS. 3 and 23 are energized, and illustrating a transverse cross-sectional region of the well depicted by a rectangular box superimposed on the image, in same relative location as that shown in FIG. 14, to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 25 is a top plan view of a sixth embodiment of an aperture plate formed in accordance with the present invention.

FIG. 25A is a diagrammatic view of one aperture of several apertures formed in the aperture plate of the present invention shown in FIG. 25, and illustrating the design considerations in the formation of the aperture plate and the apertures thereof. FIG. 25A is identical to FIG. 23A except for the added large, centered detection opening, indicated (as the other two holes) by shading. For each aperture of the several apertures formed in the aperture plate, the first and second openings, the tangent cutouts, and the central detection opening extend perpendicularly through the entire thickness of the aperture plate.

FIG. 26 is an enlarged, optical, transverse cross-sectional image of the centered well of the microtiter plate similar to the image shown in FIG. 24, and showing the illumination of the centered well when multiple LEDs (light emitting diodes) of a light source of the optical imaging system and aperture plate of the present invention respectively shown in FIGS. 3 and 25 are energized, and illustrating a transverse cross-sectional region of the well depicted by a rectangular box superimposed on the image, in same relative location as that shown in FIG. 24, to show the portion of the well that would be in an object field of view of a conventional image detector or camera, such as a focused microscope or CMOS or CCD camera, of an optical imaging system, the image including position coordinates and a scale of relative illumination (incoherent irradiance).

FIG. 27 is a side elevational diagrammatical representation of computer-generated rays of light emanating from a single LED of the light source and passing through an aperture of an aperture plate forming part of an optical imaging system of the present invention to impinge on a well of a microtiter plate, and illustrating how, in a preferred method of the present invention, the outer side walls of the well are intentionally not irradiated directly, that is, by rays that do not first pass through a portion of the bottom of the well.

FIG. 28 is a perspective diagrammatical illustration showing the positioning of aperture-defining openings formed in the top surface and bottom surface of the aperture plate shown in FIG. 23.

### DETAILED DESCRIPTION OF THE PREFERRED EMBODIMENTS

The present invention, taking advantage of a light source 2 in an optical imaging system 4 comprising multiple, arranged LEDs (light emitting diodes) 6, not only provides a substantially homogeneous irradiance at the illumination plane of a targeted object 8, such as disclosed in the aforementioned U.S. Pat. No. 7,616,317, but also provides an illumination or detection field, or both, which can be made very “flat” optically, which is an important advantage for quantitative analyses in which the detected fluorescent or scattered intensity per small component or area is meaningful. Furthermore, the present invention advantageously limits the illumination only to defined areas of the object 8.

Some examples of why this limitation might be desired include:
Dark field illumination of the underside of a clear plastic microtiter plate well 8 for quantitative fluorescence detection. Illumination of the cylindrical or slightly conical side wall 10 can cause light rays 12 (from a nearby LED 6) that illuminate the side wall 10 near the bottom 14 of the well 8 to refract into the well 8, enhancing the fluorescence excitation irradiance at areas of the well bottom 14. This irradiance can excite comparatively more fluorescence intensity from these areas of the well bottom 14, adding uncertainty to the concentration of the fluorophores in these areas.
Quantitative fluorescence of a large area wherein it is desirable, for achieving a low, accurate fluorescence limit of detection, to minimize photobleaching of this area by the bright, multi-LED source 2 typically necessary for the low limit of detection with acute or obtuse illumination. This photobleaching mitigation is achieved by illumination of that portion of the region of interest from which fluorescence can be detected. Adjacent areas might be not irradiated at all, or comparatively much less irradiated. For example, in a 96-well microtiter plate 16, and with fluorophores sensitive to photobleaching, the illumination should be limited to primarily the well 8 being tested. This consideration also applies to limiting illumination to specific areas of a sample container whose detectable area is larger than the field of view of the imaging optics.
Samples with substantial depth and light-scattering capability that, by illuminating portions of the sample outside of the field of view of the imaging optics, would obtain detectable effects of light scattering into the field of view from scattering centers outside of it. Here, too, the concern is for the accuracy of quantitative fluorescence or scattering measurements.

In illustrating and describing the invention, reference is generally made to detection of a fluorescent sample within the well 8 of a 96-well microtiter plate 16, and with the sample illuminated by a ring of nine LEDs 6 arranged symmetrically about the LED mounting wall or support 18 of the frustum of a right circular cone. Again, this type of illumination configuration is detailed in U.S. Pat. No. 7,616,317, the disclosure of which is incorporated herein by reference. The bottoms 14 of the microtiter plate wells 8 considered are substantially flat and circular. It is assumed that an x, y positioning stage moves the microtiter plate 16 relative to the multi-LED source 2, optics and detector 20.

However, this specific configuration can be generalized to include other sample container shapes (rectangular, elliptical, etc.), thicknesses, and materials. The number, arrangement and wavelengths of the LEDs 6, their mounting angle—including flat, that is, no frustum of a finite right circular cone—and far-field viewing angle can be designed to optimize the optical system 4 for the specific detection application considered. These changes are still within the scope of this disclosure.

Reference should be made not only to the figures included, but also to the included descriptions of the figures as well.

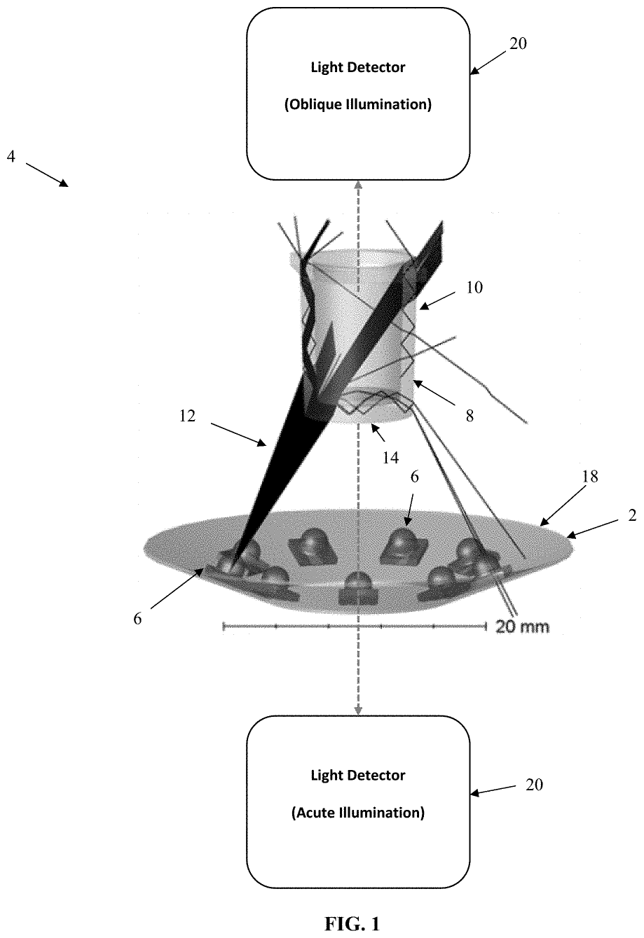

Reference should initially be had to FIG. 1 of the drawings, which is a view of one centered microtiter plate well 8 and the LED frustum 18, with some light rays 12 from the emitting point of one LED 6 traced in the plane that contains both the centerline of that LED 6 and the centerlines of the well 8 and frustum 18. As depicted, the nominal peak wavelength of the LED 6 is 528 nm and the material of the microtiter plate 16 is polystyrene.

FIG. 1 shows the necessary detection optics 20 (which may include objective and other lenses and an imaging device) that would complete the depicted imaging system 4. The detection optics' optical axis is coincident with the symmetry axis of the light source 2. The detection optics 20 could be located below (e.g., an inverted microscope configuration) the light source 2, receiving scattered or emitted light radiated downward, or above (e.g., a conventional microscope configuration) the microtiter plate 16, receiving scattered or emitted light radiating upward.

As shown in FIG. 1, and to facilitate an understanding of the invention, all light rays 12 should be considered as having originated from the LEDs' nominal emitting points, and without refraction by the LED's lens. Except for close work, this approximation is typically adequate. For close work, it will be more accurate to measure and explicitly account for the LED's near-field irradiance pattern.

Although not relevant for FIG. 1, but for many subsequent figures, the probability of emitted rays 12 is constrained to provide the far-field viewing angle's intensity profile, again originating from the LED's emitting point.

The limited number of potential rays 12 shown in FIG. 1 (in solid lines) for just one LED 6 was selected to show light irradiating both the near (to the emitting LED 6) bottom 14 and side 10 of the centered well 8. The point of FIG. 1 is that, depending upon their emission angle from the LED 6, the rays 12 can take a wide variety of refractive and transmissive paths, some upward through the well 8 and some totally internally reflected within the well 8 and the solution or suspension it contains.

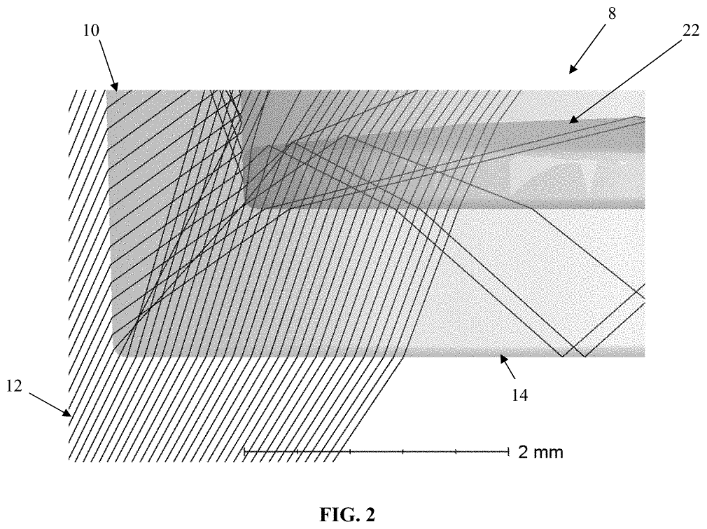

FIG. 2 is a nearer view of the same rays 12 depicted in FIG. 1, showing their interactions with part of the plate well 8 and a stylized 20 μl aqueous solution or suspension 22 contained by the well 8. The rays 12 are spaced 0.25° apart, and traced from the approximate far-field emitting point of the LED 6. The angular range of the rays 12 shown in FIG. 2 and in FIG. 1 is −1.5° to 11.75° relative to the centerline of the LED 6. Positive ray angles are defined to intersect the centerline of the frustum 18 nearer the frustum 18 (that is, lower in elevation) than does the centerline of the LED 6.

More specifically, FIG. 2 depicts the exact same rays 12 as in FIG. 1, but in this case with the fan of rays 12 in the plane of the FIG. 2 image. The view shown in FIG. 2 is achieved by rotating the source 2 and well 8 and zooming in on the lower left hand corner of the well 8. The assumed aqueous solution or suspension 22 is highly stylized, but with the constraint that it represents a 20 microliter volume. Depending on the well material, surface finish, and the contact angle of the solution or suspension 22 on the well surface, the curvature of the top of the contained liquid 22 will vary.

In the view of FIG. 2, it should be noted that many of the rightmost rays 12 follow an orderly path angling upward toward the right through the well 8, then the aqueous sample, and then the air within the well 8 itself. The refractions at each surface are discernible.

To the left of these rays 12 are other rays 12 that still irradiate the bottom 14 of the well 8, but now are totally internally reflected within the well wall 10. As FIG. 1 shows, these rays 12 will eventually exit the well 8 at the top of its wall 10. Finally, the some of the rays 12 that illuminate the lower outside of the well 8 can also be refracted into the sample solution or suspension 22. In certain regions within the well 8, these rays 12 can contribute to extra irradiance within the well 8.

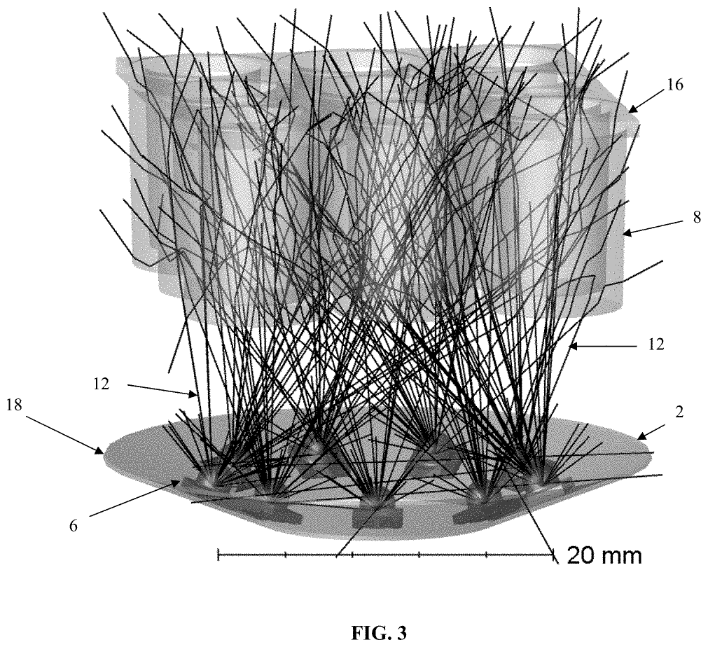

FIG. 3 is a similar view to that of FIG. 1, but now with 25 semi-random rays 12 traced from each of nine LEDs 6, and showing more wells 8 nearby the centered well 8 shown in FIG. 1. More specifically, and in contrast to the orderly rays 12 from an LED 6 as shown in FIG. 2, FIG. 3 depicts 25 pseudo-random rays 12 emitted from each LED 6, and nearby wells 8 for these rays 12 to interact with. The only requirement of the random rays 12 emitted from each LED 6 is that their directional probabilities match the typical far-field viewing angle of the LED 6. For the example figures herein, the LEDs 6 are marketed by OSRAM Opto Semiconductors Inc. of Sunnyvale, Calif., part number GT CS8PM1.13-LQLS-26, and with an 80 degree viewing angle.

In FIG. 3, rays 12 that seem to disappear nearby their LED sources 6 would not otherwise illuminate any optical component shown in FIG. 3.

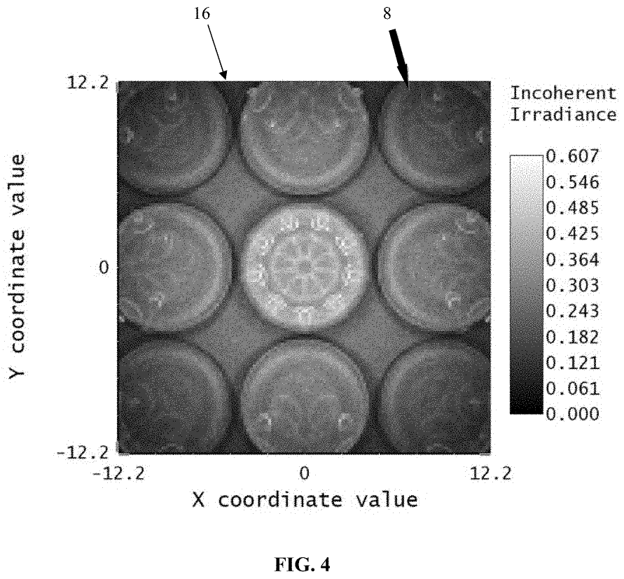

Reference should now be had to FIG. 4 of the drawings, which is a view of the relative light intensities in a plane that slices through the wells 8 shown in FIG. 3. This plane is located 2.5 μm from the inner, bottom surfaces of the wells 8, and parallel to them. One million semi-random rays 12 from each of nine LEDs 6 were traced. These rays 12 are semi-random in that their directional probabilities match the far-field viewing angle intensities of the LEDs 6. The gray scale is reversed from the previous three figures (FIGS. 1-3) in that, in FIG. 4, more irradiance is rendered as whiter and less irradiance as blacker.

More specifically, FIG. 4 shows the local irradiance very near the bottom 14 of the wells 8 shown in FIG. 3, where, for example, chromophores or fluorophores concentrated on particles in a suspension 22 may have settled to the bottom 14 of the wells 8. But, in addition to showing the irradiance within the 20 microliter aqueous solution or suspension 22, FIG. 4 shows the irradiance even within the (as depicted, clear polystyrene) material of the wells 8 themselves. Compared to FIG. 3, 40,000 times more rays 12 are traced from each LED 6 in order to generate the patterns shown in FIG. 4.

All wells 8 have some detailed irradiance pattern within them and, clearly, there are areas more strongly irradiated than others. The exact pattern will vary even with minor changes in well geometry and material; solution or suspension refractive index, contact angle, and volume; and LED emission wavelength and viewing angle. The pattern is also sensitive to the resolution of the discrete irradiances detected.

The edge of the actual inner wall of the central well 8 shown in FIG. 4 occurs at the inner interface between the diffuse lighter ring and the darker ring that the lighter ring surrounds. This inner wall interface is outside of the inner, brighter “wheel with spokes” apparent structure in the image.

In FIG. 4, and all subsequent irradiance grids shown in the figures, the x and y axes' units are millimeters.

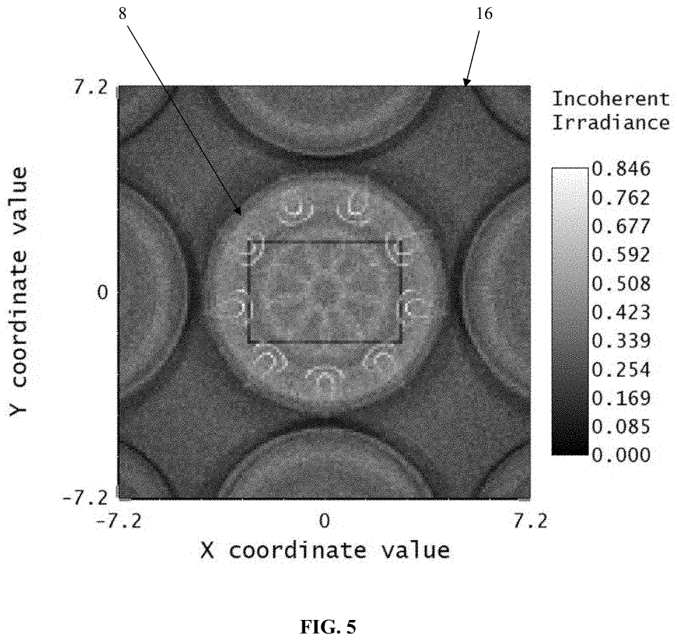

FIG. 5 is a view similar to that of FIG. 4, in that one million semi-random rays 12 from each LED 6 are traced. In addition, the view of FIG. 5 identifies a region, within the black rectangular box, that can be imaged with a 5.25 mm×3.50 mm object field of view of, for example, a focused microscope. This field of view fits within the center of the circular well 8, with little room to spare. The centered well's inner walls can be discerned as the circular, diffuse, lighter gray region immediately outside the corners of the rectangular box.

More specifically, FIGS. 4 and 5 are similar in what they show, except that in FIG. 5, the detection area is reduced to provide a higher resolution view of the center well 8. As shown, the discrete irradiance areas—within which irradiating rays are summed—are 0.10 mm×0.10 mm squares. Also superimposed on this image, as a dark gray rectangle, is the field of view that might be visible to a low power microscope. For the example shown in FIG. 5, this microscope has 2.5× magnification and a FLIR Blackfly S 20 MP digital camera manufactured by FLIR Systems, Inc. of Goleta, Calif. With these selections, the field of view is 5.25 mm×3.50 mm. Again, the exact irradiation pattern is subject to the variables listed above but, clearly, the irradiance is uneven.

With the field of view centered on the axial center of symmetry of the well 8, as is shown in FIG. 5, the radial distance to the corners of the field of view is approximately 99% of the radial distance to the well's inner wall at the well bottom 14. If an image very near or at the well bottom 14 were obtained with the single field of view shown in FIG. 5, this image would cover 57% of the well's inner bottom area.

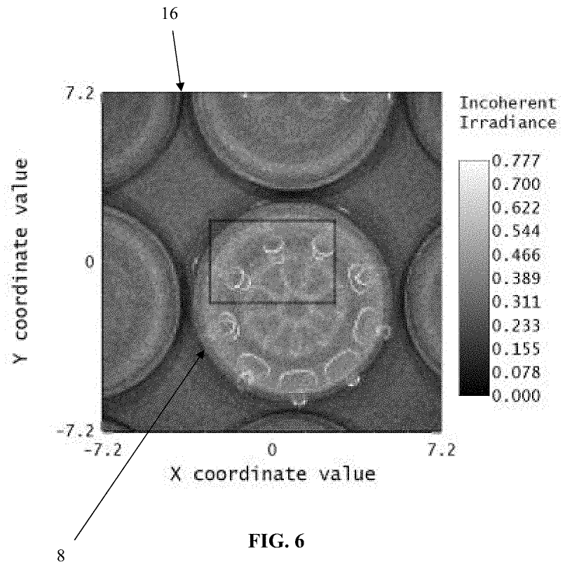

In order to cover the entire well's area with the example field of view, four images are required. In this case, every image will include portions of the well's cylindrical wall 10 and even an area past that wall 10. One of these four image areas may be indicated in FIG. 6. To obtain an image at the field of view shown in FIG. 6, one would offset the well 8 toward its lower, right hand side as shown, assuming the illumination and microscope positions remain constant. Thus, the vertical spacing between the well 8 and the source 2 and microscope 20 remain constant.

More specifically, FIG. 6 is a view similar to that of FIG. 5, but now with the microtiter plate well 8 offset relative to the LED frustum 18 and the microscope 20. Relative to this image, the well offset is toward the lower right hand side of the well 8, and the image includes parts of the well walls 10 in order to ensure that the entire upper left hand side of the well 8 is imaged. Three more, similar images of the well 8 can also be obtained—of the upper right hand side and the lower left and right hand sides. A view of the entire well 8 can be reconstructed by digitally stitching these four images together. It should be noted that the axial symmetry of the FIG. 5 illumination pattern is distorted by this offset, as the lower right hand side of the well 8 is now closer to its nearest illumination LEDs 6, whereas the upper left hand side of the well is now farther from its nearest illumination LEDs 6.

The approximate nine-fold symmetry of the irradiance pattern is distorted by the decentration of the well's cylindrical axis relative to those of the microscope 20 and source 2.

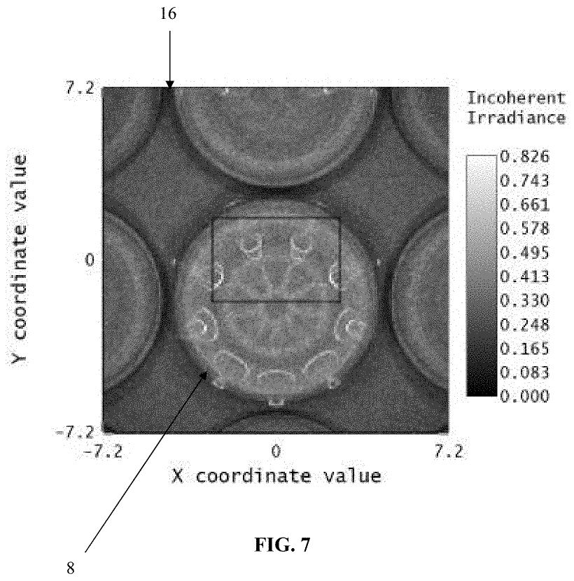

FIG. 7 is a view similar to those of FIGS. 5 and 6, but with the microtiter plate well 8 offset toward the lower side of the well 8, the image again including parts of the well wall 10 in order to ensure that the upper center of the well 8 is imaged. Portions of the well 8 near its left and right hand side walls 10 are not visible in this image. One more similar image of the lower side of the well 8 can also be obtained. A view of over 90% of the well's inner bottom surface area can be reconstructed by digitally stitching these two images together. Again, the axial symmetry of the FIG. 5 illumination pattern is distorted by this offset, as the lower side of the well 8 is now closer to its nearest illumination LEDs 6, whereas the upper side of the well 8 is now farther from its nearest illumination LEDs 6.

More specifically, FIG. 7 is similar to the view shown in FIG. 6, except that the microtiter plate well 8 being imaged is only moved downward according to the plane of the image shown. The image of FIG. 7 can be combined with a similar image where the microtiter plate well 8 is moved upward—in the opposite direction—in order to cover more than 90% of the well's area with the two images. A little more than 95% of the well's area can be covered by three images, for example, with the field of view shown in FIG. 6, plus another field of view offset in the same vertical direction from centered, as is FIG. 6, but in this case by the same magnitude to the right hand side. The third field of view might be centered horizontally, but with the well 8 offset vertically opposite (upward) that shown in FIG. 7.

In all of these cases there will be variable, often structured, irradiance patterns within each well 8. These patterns may not be consistent from well to well 8. This inconsistency can be caused by variations from microtiter plate to microtiter plate 16, and to well variations within a single microtiter plate 16. Similarly, bubbles or inhomogeneities in the sample solution or suspension 22, LED-to-LED optical and positioning variations, and well positioning imprecision can all cause variability in the well-to-well irradiance patterns.

One of the purposes of the invention disclosed herein is to make the irradiance or the image field very “flat” across the entire well bottom's area. Making the image field flat means that, for incremental areas with precisely equivalent fluorescence or scattering intensity emitted, the detected fluorescence or scattering is also highly consistent between incremental areas of the image, within the well bottom's area.

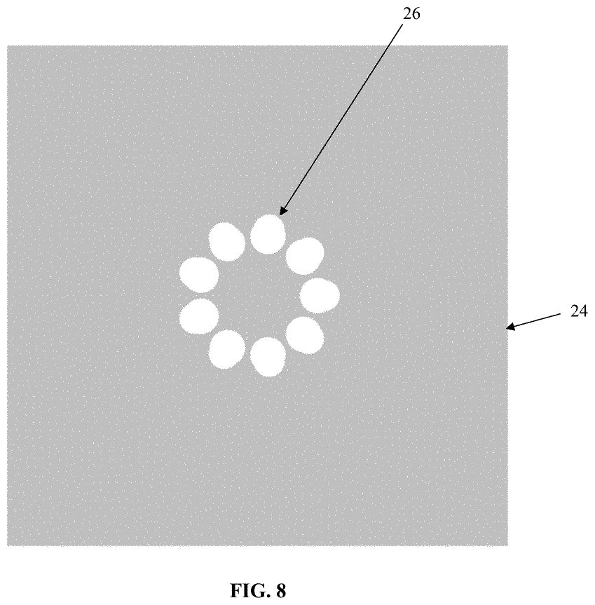

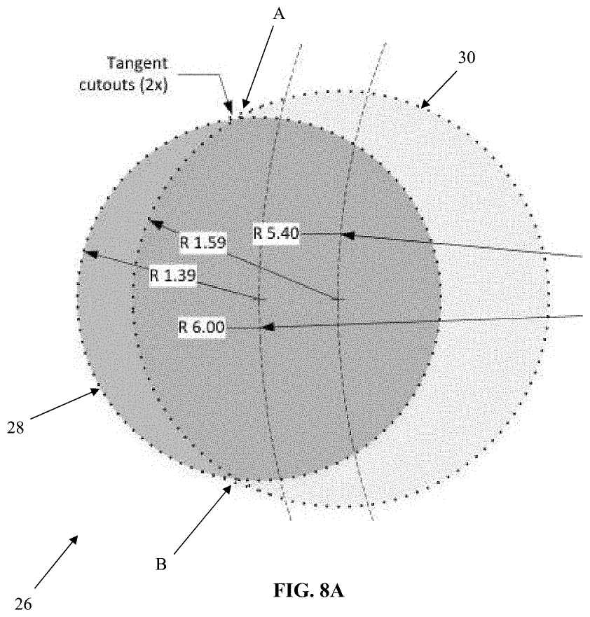

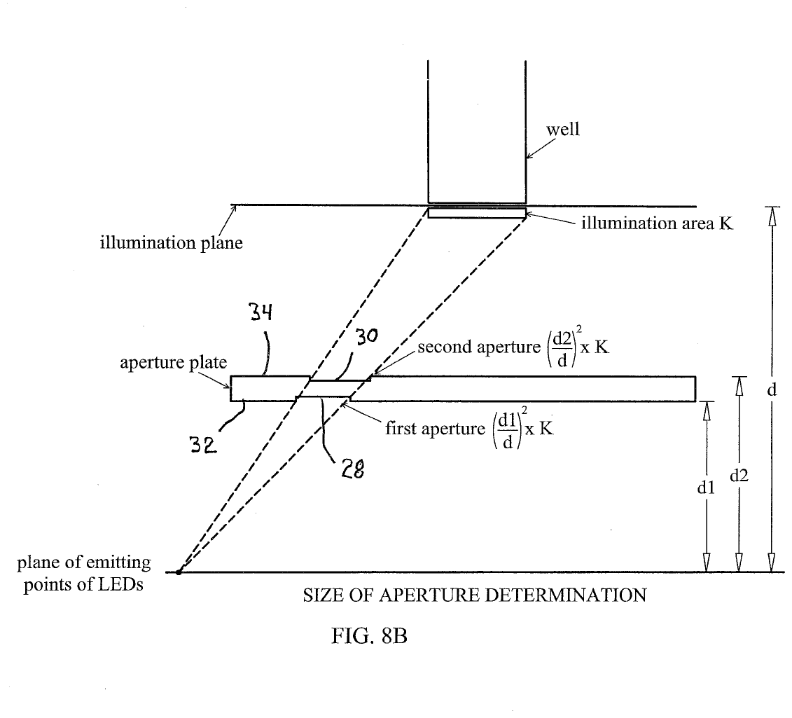

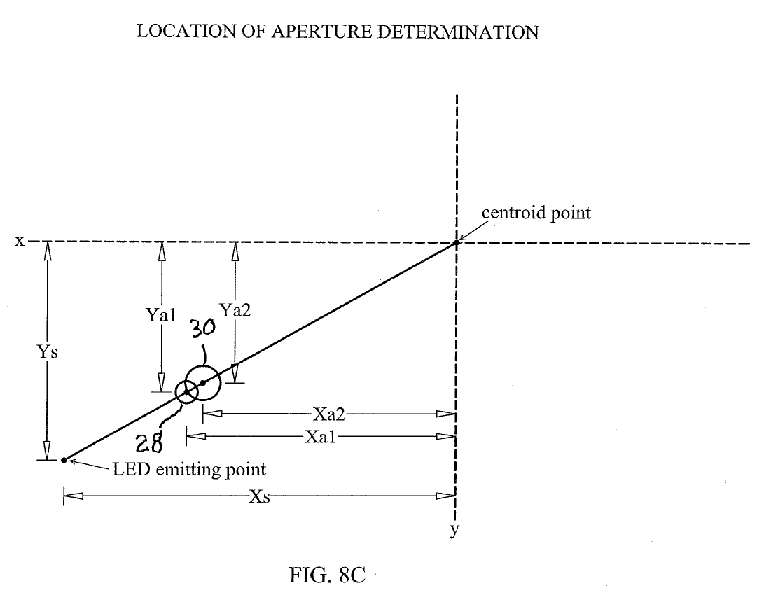

To address this goal, it is necessary to block or substantially attenuate the light emitted by the LEDs 6 from illuminating the sides 10 of the microtiter plate wells 8 prior to their irradiating the desired well bottom 14. The complex aperture plate 24 of the present invention and the apertures 26 formed therein and shown in FIG. 8 and subsequent figures are configured to achieve this purpose. As shown, the aperture plate 24 includes nine-fold symmetrically situated apertures 26 about its center axis, in order to match the nine LEDs 6 employed in the example light source 2.

More specifically, a moveable aperture plate 24 formed in accordance with the present invention is shown in FIG. 8 of the drawings. This aperture plate 24 could be used for obtuse angular, dark field illumination in a conventional microscope's (or a digital camera with lens') optical imaging system 4, where the optics (objective lens, etc.) 20 are located above the microtiter plate well 8 and the obtuse illumination originates from below the microtiter plate 16. The aperture plate 24 is moved in proportional x, y magnitudes, and in the same x, y direction, as the microtiter plate well 8 is moved in order to obtain images of sections of a well 8. Both the well's and the aperture plate's motion are confined, within the limits of the motion system, to the x, y plane. This plane is normal to the optical centerlines of the LED frustum 18, the optics' objective lens 20, and the centerlines of the microtiter plate wells 8. Preferably, the range of motion of the microtiter plate 16 would cover at least all portions of the 96 wells 8 of the microtiter plate 16, whereas the range of motion of the aperture plate 24 would only cover views of a single well 8.

Even more specifically, and in one form of the present invention, the aperture plate 24 shown by way of example in FIGS. 8 and 8A is comprised of two sets of nine holes, or openings 28, 30, the holes 28, 30 of each set being spaced apart from each other in a circular arrangement, both sets' diameters and positions fabricated to just permit light emitted from an LED's emitting point to irradiate the circular bottom of the target well 8, preferably with a slight excess area beyond the well diameter, but safely inside the outer walls 10 of the well 8. The radially outer set of first holes 28, with the smaller diameters, is set to block the light with the bottom 32 of the aperture plate 24. The radially inner set of second holes 30, with the larger diameters, is set to block the light with the top 34 of the aperture plate 24.

If it were possible to make the aperture plate 24 infinitely thin, then the sets of holes 28, 30 would coalesce into nine circular holes. With some thickness to the aperture plate 24 in which the sets of holes 28, 30 are formed, the radially inner holes 30 are larger and fabricated on a smaller bolt circle about the aperture plate's axis of symmetry than that of the radially outer set of holes 28. As shown by way of example in FIG. 8, the two sets of circular holes 28, 30 substantially overlap, resulting in nine egg-shaped oval holes or apertures 26 formed through the thickness of the aperture plate 24. Ideally, each of the two overlapping circular holes 28, 30 for a single LED 6 are connected by two line segments A, B (see FIG. 8A) tangent to the periphery of each hole 28, 30, and obtaining no local concavity in the resulting egg-shaped oval apertures 26. But small concavities are acceptable, as can be barely discerned in the apertures 26 shown in FIG. 8.

The centerline of the aperture plate 24, meaning the centers of the two concentric arrangements of radially outer and inner sets of holes 28, 30, is moved proportionally to the centerline of the microtiter plate well 8 being assayed. In this way, the LED sources 6 always provide illumination of the entire test well bottom 14, even when non-axial areas of the well 8 are imaged. Furthermore, light rays 12 are prevented in all cases from travelling through the well's side walls 10 before traveling through the solution or suspension 22 at the bottom 14 of the well 8. The microtiter plate 16 is moved to position each well 8 to be assayed, one at a time, in the irradiation and detection path of the microscope 20. But the aperture plate 24 only must be moved to position it relative to the position of the test well 8; the aperture plate's range of motion is typically much smaller than and proportional to the motion of the microtiter plate well 8 being assayed from its centerline.

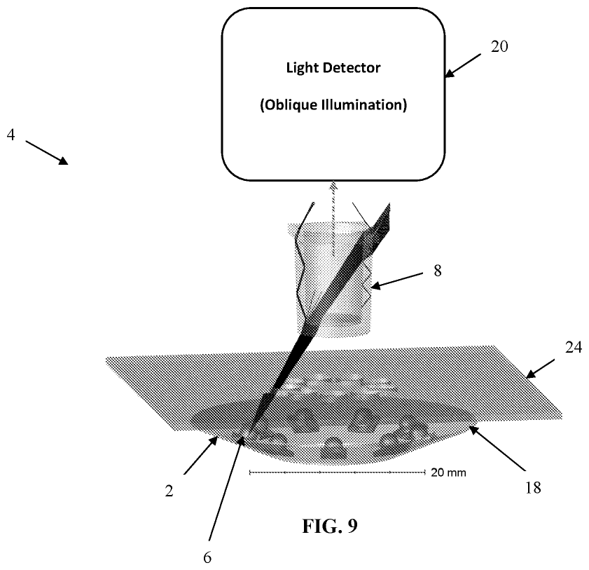

In the examples given in the figures, the emitting points of the LEDs 6 (FIGS. 1, 3 and 9) are located on a 10.0 mm bolt circle radius about the centerline of the frustum 18. The LEDs 6 themselves are mounted on the inner surface of a printed circuit board 18 formed into a frustum of a right circular, downward pointing cone with an apex angle of 135.6 degrees. As shown in FIGS. 8 and 9, the aperture plate 24 and through depth of the apertures 26 are 0.75 mm thick, with the holes 28 of the radially outer set of holes 28 positioned on a 6.00 mm bolt circle and with 1.39 mm radii. The holes 30 of the radially inner set of holes 30 are located on a 5.40 mm bolt circle and with 1.59 mm radii, as shown in FIG. 8A.

The lower face 32 of the aperture plate 24 is positioned 5.00 mm above the LED emitting points, and the outer, lower bottom of the microtiter plate 16 is located 11.91 mm above the LED emitting points.

The frustum's cone apex angle and the emitting point bolt circle were selected to optimize irradiance flat-fielding when the irradiance target is, in air, 12.5 mm above the LED emitting points. In all of the figures shown herein, the microtiter plate 16 is based on part number 655101, manufactured by Greiner Bio-One GmbH of Frickenhausen, Germany, and with a 1.12 mm thick molded well bottom thickness. Thus, the inner, upper bottom of the microtiter plate 16 is situated 13.03 mm above the LED emitting points, a position that approximately maintains the optimum ray angles for illumination flat-fielding but for the inner, upper bottom of the polystyrene Greiner microtiter plate 16.

FIG. 9 is a view of the same rays 12 depicted in FIG. 1, but with the aperture plate 24 and apertures 26 of FIG. 8 centered in order to block rays 12 from illuminating the outer wall 10 of the microtiter plate well 8, thereby providing a more constant irradiance gradient within the well 8, decreasing from nearest the LED 6 to farthest from the LED 6. FIG. 9 does not show the necessary detection optics (objective and other lenses and imaging device) 20 that would complete the depicted imaging system 4. If shown, the detection optics' optical axis would be coincident with the symmetry axis of the light source 2. The detection optics 20 would be located above (e.g., a conventional microscope configuration) the microtiter plate 16, receiving scattered or emitted light radiating upward.

This configuration can be used for both scattering or fluorescence measurements. But this configuration is more preferred for cases where the sample holder is planar, with a defined top and bottom—such as with a microscope slide or other sample holders whose contained sample thicknesses are defined by clear, planar layers—than for microtiter plates 16.

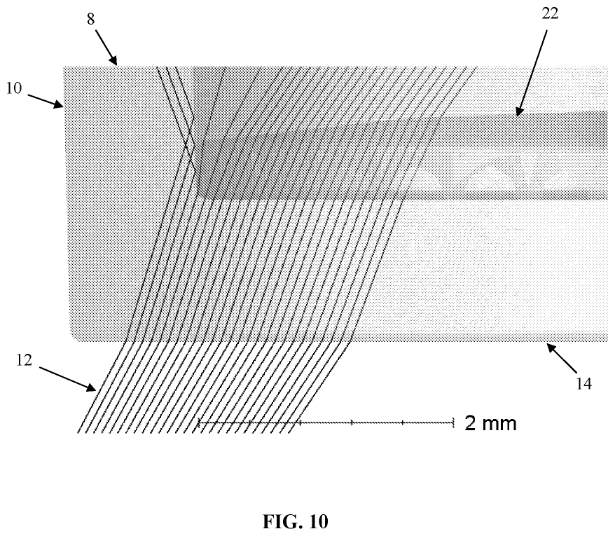

Likewise, FIG. 10 is a view similar to that of FIG. 2, but now with the centered aperture plate 24 and apertures 26 in place, again showing that the rays 12 are blocked from illuminating the outer wall 10 of the microtiter plate well 8 prior to illuminating the sample 22. Stated another way, FIGS. 9 and 10 correspond exactly to FIGS. 1 and 2, respectively, except that in FIGS. 9 and 10, the aperture plate 24 and apertures 26 shown in FIG. 8 are positioned as described above. In both of FIGS. 9 and 10, the apertures 26 of the plate 24 clearly block the rays 12 that otherwise would have illuminated the side walls 10 of the microtiter plate well 8, as were shown in FIGS. 1 and 2.

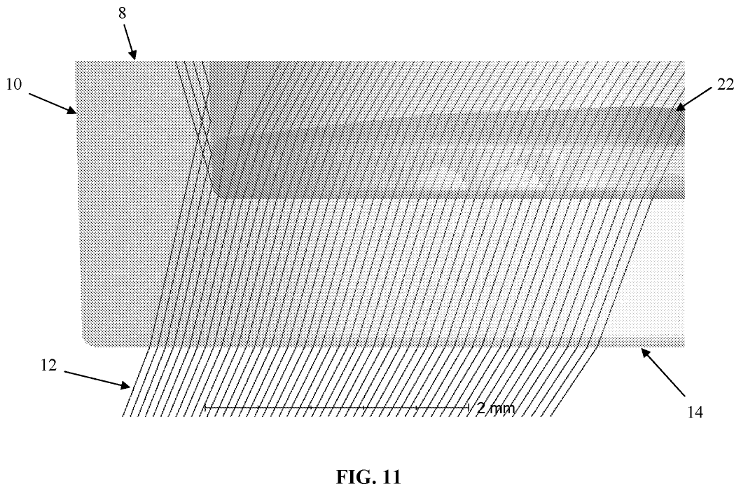

FIG. 11 is a view similar to that of FIG. 10, with the same rays 12 originating from one LED's emitting point, but now with the microtiter plate 16 and its aqueous solution or suspension 22 moved 1.71 mm closer to the single LED 6 providing the illumination, but in the plane that is perpendicular to the frustum's and wells' centerlines. The aperture plate 24 is also moved in its plane (perpendicular to the frustum's and wells' centerlines) proportionately closer to the LED 6. More specifically, the aperture plate 24 is moved such that the respective aperture 26 of the energized LED 6 is shifted 0.68 mm closer to the same LED 6, where 0.68 mm/1.71 mm=0.40. This is the same ratio as the differences between each of the vertical positions of the aperture plate bottom 32 and the approximately equivalent position, in air, of the optimized flat illumination field, both relative to the LED emitting points, 5.00/12.5=0.40. Because of the change of the angles of incidence of the rays 12 due to the microtiter plate's motion, more rays 12 are visible than in FIG. 10 but, still, no rays 12 can illuminate the well's side wall 10 due to the proportional motion of the aperture plate 24.

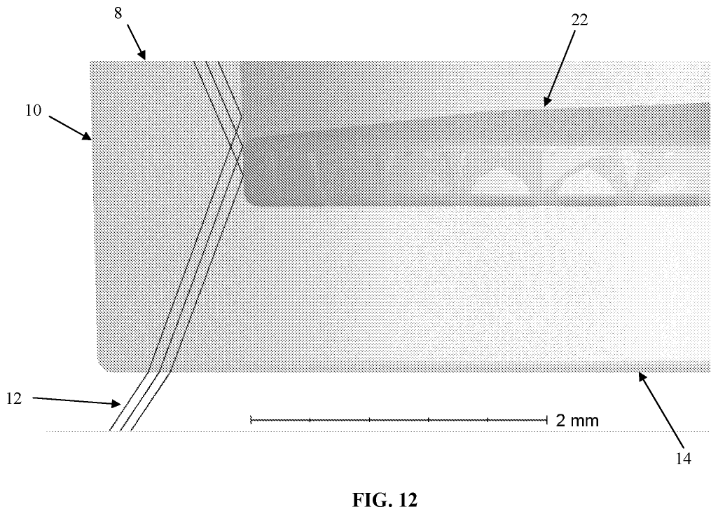

FIG. 12 is the complement to FIG. 11, but with the well 8 and aperture plate 24 moved 1.71 mm and 0.68 mm, respectively, farther from the one LED 6. In both figures, rays 12 from the LED 6 cannot illuminate the well's liquid contents 22 after first passing through the side wall 10 of the well 8.

More specifically, FIG. 12 is a view similar to those of FIGS. 10 and 11, with the same rays 12 originating from one LED's emitting point, but now with the microtiter plate 16 and its aqueous solution or suspension 22 moved 1.71 mm away from the LED 6, again in the plane that is perpendicular to the frustum's and wells' centerlines. Also similarly, the aperture plate 24 is moved in its plane (perpendicular to the frustum's and wells' centerlines) such that the respective aperture 26 corresponding to the energized LED 6 is shifted proportionately farther from the LED 6. Because of the change of the angles of incidence of the rays 12 due to the microtiter plate's motion, fewer rays 12 are visible than in FIG. 10 but, yet again, no rays 12 can illuminate the well's side wall 10 due to the proportional motion of the aperture plate 24. The inner, bottom of the well 8 can still be irradiated by rays 12 from the LED 6, but at angles greater than the 11.75 degree limit of the rays 12 shown in this and the previous two figures (FIGS. 10 and 11).

In this example, the same 0.40 ratio is maintained between the outer set of first holes' bolt circle in the aperture plate 24 and the bolt circle of the LEDs 6, (10.00 mm-6.00 mm)/10.00 mm. Finally, the ratio is also maintained in the radii of the outer set of first holes 28 in the aperture plate 24 relative to the desired irradiation radius, 1.39 mm/3.46 mm. The irradiation radius is preferably chosen to be slightly larger than the top surface of the bottom 14 of the microtiter plate wells 8, 3.20 mm, in order to allow for some mechanical misplacement of the microscope optics 20, LED sources 6, microtiter plate 16 and aperture plate 24.

Because the top 34 of the aperture plate 24 is located at 5.75 mm vertically above the LEDs' emitting points, the target ratio now becomes 5.75 mm/12.5 mm=0.46. Thus, the radii of the radially inner second holes 30 are 3.46 mm*0.46=1.59 mm and their bolt circle is at 10.00 mm*(1−0.46)=5.4 mm.

The example described herein illustrates the design concepts for forming the aperture plate 24 of the present invention and the apertures 26 therein, and the optical imaging system 4 of the present invention. In summary, one should first begin with the selection of the number of illumination LEDs 6, their bolt circle radius, their equivalent in-air vertical spacing between the LEDs 6 and the irradiance target 8, the size and shape of the irradiance target 8, and the position and thickness of an aperture plate 24. From this information, a set of apertures 26 defined by the first and second holes or openings 28, 30 can be specified for the aperture plate 24. This specification includes the sets of holes 28, 30 in the plate 24—their shapes, positions and bolt circle radii.

The example selected was for the irradiance of a selected microtiter plate's equivalent inner, bottom surface area of one well 8. But other areas and other well shapes could have been selected. For example, if the desired irradiance area of the object, such as a well 8 of a microtiter plate 16, were rectangular or elliptical, etc., then the plate aperture-defining holes 28, 30 would have to be specified according to the same desired irradiance shape, but proportionately smaller and on a proportional bolt circle. Also, the holes' symmetry axes would have to be aligned parallel to the symmetry axes of the desired irradiance shape.

Typically, the aperture plate 24 will be fabricated from a sufficiently rigid, shape-preserving material such as aluminum, steel, or other machinable, castable, or stampable metal, or of molded plastic. Also, the aperture plate's surfaces 32, 34, including inside the apertures 26 and aperture-defining openings 28, 30, ideally will be highly matte and absorbing. But, as in the example given, the angles of the illumination and reflection can often be selected to mitigate detectable specular reflections, thus lessening the need for a highly matte finish.

The aperture plate 24 shown in FIG. 8 will work well for dark field illumination, where the LED sources 6 are located at an obtuse angle relative to the centroid angle of the detection optics 20. The plate 24 will also work well for some obtuse illumination, fluorescence measurement cases where, for example, the sample holder is planar, top and bottom, over an area that extends beyond the entire desired object field of view.

As mentioned previously, the LEDs 6 of the light source 2 used in the examples and in creating the computer-generated images disclosed herein are Part No. GT CS8PM1.13-LQLS-26 marketed by OSRAM Opto Semiconductors Inc., having a viewing angle of about 80 degrees. The LED viewing angle is selected based upon trying to achieve a substantially homogeneous irradiance, or flat detection field. The size of the target area, the centerline spacing between the target area and the LED sources 6, and the angle at which the LEDs 6 are mounted relative to the optical centerline, are what either drive the selection of the LED viewing angle or, more commonly, are set based on the LED viewing angles available. The technology of the disclosure herein can be agnostic of the viewing angle of the LEDs 6. The full width at half maximum intensity viewing angle will almost always be in the range from 10 to 140 degrees and, often preferably but not exclusively, in the range from 60 to 120 degrees.

Furthermore, the disclosure herein is written from the viewpoint of illuminating the target area with LEDs 6 all of the same part number and, therefore, similar emission wavelengths and viewing angles. If a set of LEDs 6 is used having substantially different wavelengths, for example, both red and green, then the LEDs 6 could be mounted either at different vertical or bolt circle spacings relative to the target. In either case, the positions of the apertures 26 and their openings 28, 30 in the aperture plate 24 would be scaled as described in this disclosure. In the case of vertical LED-to-target spacing changes, then the sizes of the apertures 26 and openings 28, 30 in the aperture plate 24 would also be scaled. In these cases, there is only an indirect consideration of wavelength, that is, if it affects the position of an LED 6 relative to the target. Additionally, the aperture and opening sizes and relative (to the optical centerline and to the target) positions of all LEDs 6 may be kept the same, optimizing and setting the refraction-modulated equivalent in-air position of the target for one wavelength, or optimizing the placement of this target according to some defined constraints.

Finally, there is no requirement for the illumination LEDs 6 to be on a particular bolt circle, or even for them to be arranged about a bolt circle. The method described in U.S. Pat. No. 7,616,317, the disclosure of which is incorporated herein by reference, or even some other reason, may guide the placement of the LEDs 6. The apertures 26 and aperture-defining openings 28, 30 can then be located according to the LED placements. Practical limits will be that apertures 26 should not be too closely spaced: (1) for the structural integrity of the aperture plate 24, and (2) because light from one LED 6 can also pass through adjacent apertures 26.

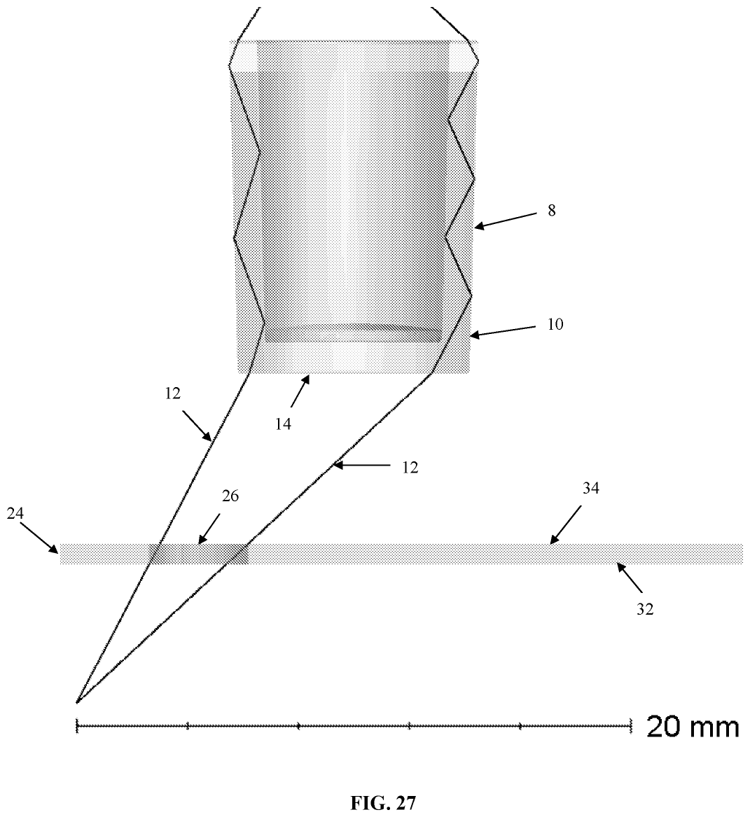

It should be noted that, by design, a little bit, side-to-side as shown in FIG. 27 outside the bottom 14 of the well 8 is irradiated. This is intentional, to account for microtiter plate and aperture plate placement uncertainties and errors. It should also be noted that the two limiting rays 12 shown in FIG. 27 are symmetrically spaced (again, side-to-side) about the bottom (inside) of the well 8. This, too, is intentional, in order to make the illumination tolerant of small misplacements.

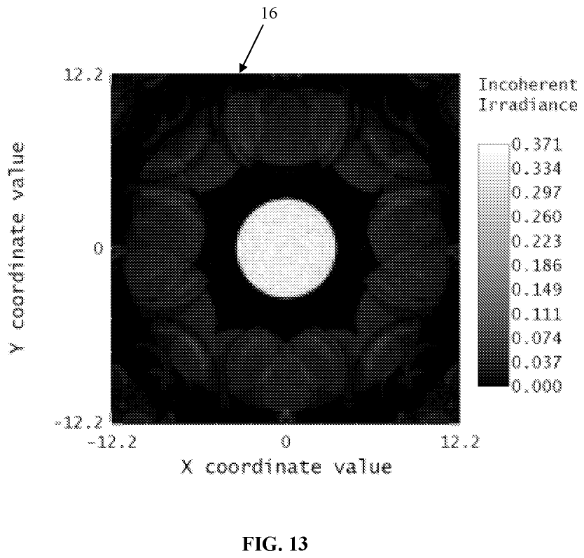

FIG. 13 is a view constructed similarly to that of FIG. 4 except for the added, centered aperture plate 24. FIG. 13 shows the relative light intensities in a plane that slices through the wells 8 shown in FIG. 3, and that the rays 12 are blocked from illuminating the outer wall 10 of the targeted microtiter plate well 8 prior to illuminating the sample 22 within the well 8. FIG. 13 also shows how the aperture plate 24, with its particularly-designed apertures 26, substantially mitigates illumination of the lower portions of other wells 8, too.

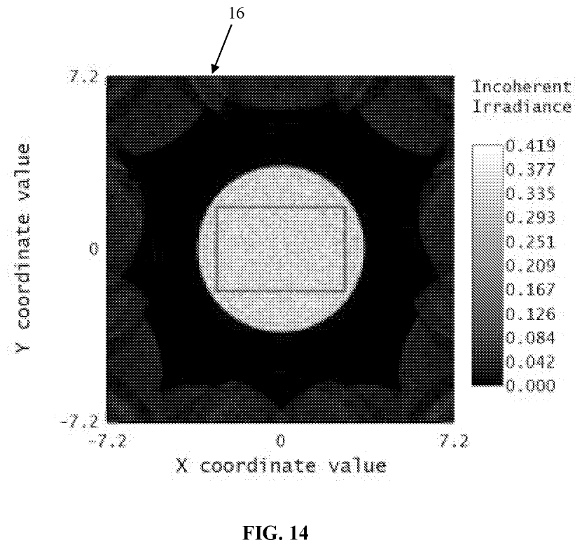

FIG. 14 is a view similar to that of FIG. 5, with the same rectangular box added and the centered aperture plate 24 and apertures 26 in place.

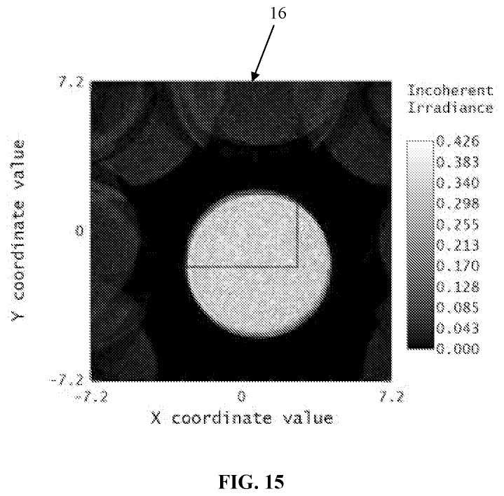

FIG. 15 is a view similar to that of FIG. 6, again with the microtiter plate well 8 offset relative to the LED frustum 18 and the microscope 20. The aperture plate 24 and the respective apertures 26 corresponding to the energized LEDs 6 are offset proportionally to the plate well 8, and in the same x, y plane and angular direction. The aperture plate 24 and apertures 26 prevent illumination of the microtiter plate's wall 10 by the nearest LEDs 6, thereby preventing light that has first passed through the wall 10 to then illuminate the inside of the plate's well 8.

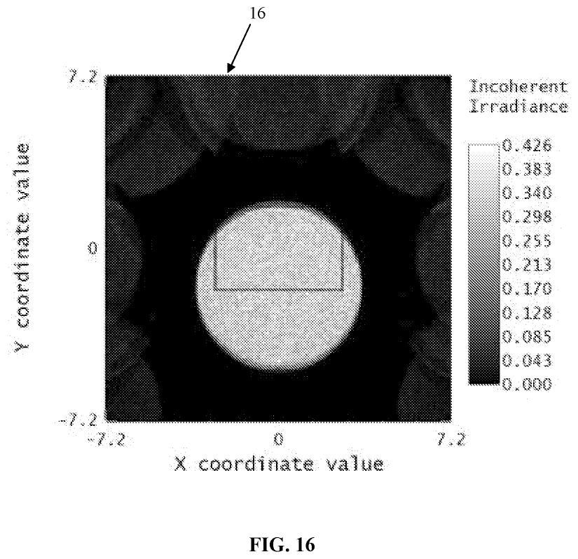

FIG. 16 is a view similar to that of FIG. 7. The aperture plate 24 of the present invention and apertures 26 formed therein again prevent illumination of the microtiter plate's wall 10 by any nearby LEDs 6, thereby preventing light that has first passed through the wall 10 to then illuminate the inside of the plate's well 8.

More specifically, FIGS. 13 through 16 are otherwise equivalent to FIGS. 4 through 7, respectively, with the exception that the aperture plate 24 of the present invention shown in FIG. 8 is added to the imaging system 4. In FIGS. 13 through 16, it can be seen that the fine structure within the centered well 8 is almost entirely eliminated by the intervening aperture plate 24 and apertures 26. It is especially evident in the optical images of FIGS. 14 through 16 that the inner wall 10 of the well 8 can be barely discerned near the outer circumference of the irradiance area. It is also evident from FIG. 15, and more faintly shown FIG. 16, that the irradiance is decreasing at the portion of the decentered well 8 opposite the field of view of the microscope 20. Nevertheless, these regions are out of the field of view.

There is detectable irradiance of some portions of the adjacent wells 8 of the microtiter plate 16, but at most about 25% of the maximum irradiance within the target well 8. Photobleaching of nearby wells 8 is thereby very substantially mitigated when using the optical imaging system 4 and aperture plate 26 of the present invention.

The stippling of the irradiance pattern within the wells 8 shown in the figures is due to the still relatively small (one million) rays 12 considered emanating from each LED 6. If one trillion rays 12 were traced, the stippling would be expected to almost disappear. Such an involved ray-tracing analysis could be performed over an extended period of time.

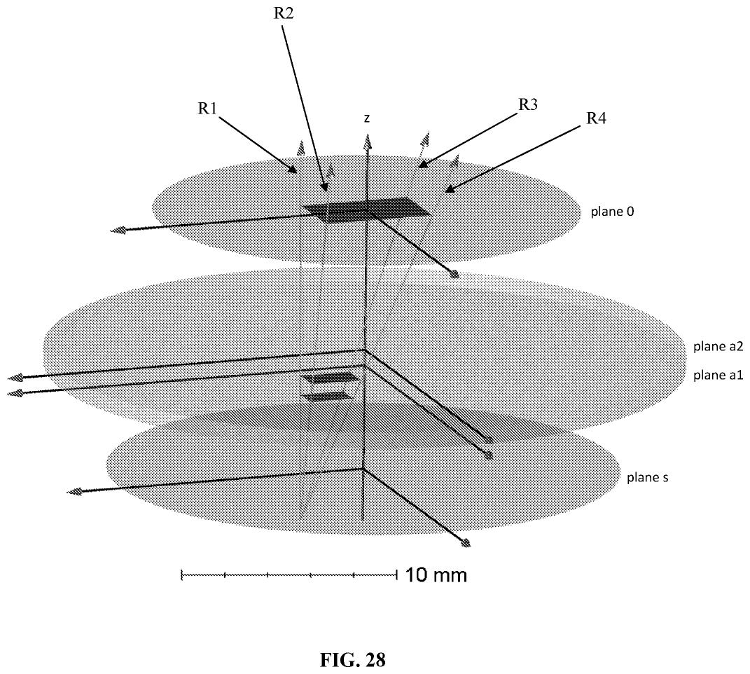

FIGS. 8B, 8C and 28 illustrate how the location of the overlapping first and second openings 28, 30 defining the apertures 26 formed through the aperture plate 24 is determined, and the algorithms and/or formulas for locating the apertures and the first and second openings defining the apertures in the aperture plate are provided below.
a. Given:
   i. A planar arrangement of the real or virtual emitting points of a set of light sources (such as LEDs 6),
   ii. An aperture plate 24 with two planar faces (e.g., a top surface 34 and an opposite bottom surface 32), and
   iii. A planar object (e.g., a well 8 of a microtiter plate 16) to be illuminated in an imaging system 4;
b. Where all four planes (see FIG. 28) are:
   i. Parallel,
   ii. Spaced apart from one another,
   iii. Configured so that the sources' emitting points illuminate the object 8, with their respective planes spaced apart by an equivalent through-air distance d, and
   iv. Configured so that the aperture plate 24 is located in between the light sources 6 and the object 8, with the spacing between the sources' plane and the nearer, first surface (e.g., the bottom surface 32) of the aperture plate 24 is defined as distance d₁ and the spacing between the sources' plane and the farther, second surface (e.g., the top surface 28) of the aperture plate 24 is defined as distance d₂;
c. The aperture plate 24 is comprised of a set of apertures 26 defined by first openings 28 formed in the first (e.g., bottom) planar surface 32 of the aperture plate 24 and second openings 30 formed in the second (e.g., top) planar surface 34 of the aperture plate 24, with these apertures 26 and openings 28, 30 defined to illuminate a specified planar shape of the object 8 as follows:
   i. For each emitting point (of an LED 6, for example) there is a first aperture opening 28 and a second aperture opening 30, the first opening 28 scaled for the first surface 32 of the aperture plate 24 and the second opening 30 scaled for the second surface 34 of the aperture plate 24,
   ii. Each aperture's planar shape is a scaled version of the desired shape of the object's illumination area, where the scaling factor of all first openings 28 is

$$\frac{{d}_{1}}{d}$$

and the scaling factor of all second openings 30 is

$$\frac{{d}_{2}}{d} ,$$

iii. Each set of first aperture-defining openings 28 and each set of second aperture-defining openings 30 are oriented such that, except for scaling, they would be congruent and equal in orientation to the specified planar shape of the object 8;
d. For the purpose of locating the apertures 26 and openings 28, 30 in the aperture plate 24, a point within the object to be illuminated is defined:
   i. This point is typically, or at least near to, the centroid of the object 8 to be illuminated,
   ii. This point defines the origin of an x, y, z three-dimensional orthogonal coordinate system for all four planes (see FIG. 28), where the other three planes' locations differ only in their z position,
   iii. A corresponding, scaled point is located with every aperture opening of the sets of first and second openings 28, 30 of the aperture plate 24;
e. Given the plane location of the emitting point of a light source, xₛ, yₛ:
   i. The plane location of the first aperture-defining opening 28 associated with this source is

$${x}_{a 1} = {x}_{s} \cdot ( 1 - \frac{{d}_{1}}{d} ) and {y}_{a 1} = {y}_{s} \cdot ( 1 - \frac{{d}_{1}}{d} ) ,$$

and
ii. The plane location of the second aperture-defining opening 30 associated with this source is

$${x}_{a 2} = {x}_{s} \cdot ( 1 - \frac{{d}_{2}}{d} ) and {y}_{a 2} = {y}_{s} \cdot ( 1 - \frac{{d}_{2}}{d} ) .$$

If the illumination area is K, then the areas of the first opening 28 partially defining an aperture 26 and the second opening 30 partially defining an aperture 26 are (d₁/d)²*K and (d₂/d)²*K, respectively, where the square is proper for area. If illumination radius is used as a metric, then the radii of the first and second openings 28, 30 are (d₁/d)*r and (d₂/d)*r, respectively.

Three other considerations are important for setting up an illumination system according to the method of the present invention for illuminating a defined area of an object: (1) guidelines for the x, y, z placement of the microtiter plate 16 and of the aperture plate 24; (2) guidelines for the x, y placement accuracy and precision of the microtiter plate 16 and of the aperture plate 24; and (3) guidelines for the limit of decentration of the microtiter plate 16 (and the proportional decentration of the aperture plate 24). These guidelines are discussed below.

The relative placements of the sources' emitting points, the aperture plate 24, and the target position are limited first by the requirement that some vertical spacing is needed between the aperture plate 24 and the microtiter plate 16. The minimization of this spacing is limited by the spacing between the bottom of the microtiter plate 16 (outside of the well 8) and the base of the microtiter plate 16, which may be on the order of 2.5 mm. With the well bottom thickness being on the order of 1.12 mm and, accounting for another approximately 0.6 mm effective thickness due to refraction within the microtiter plate 16, already at least (2.5+1.1−0.6) mm=3.0 mm spacing is needed between the target, top, inside of the microtiter plate well 8 and the top 34 of the aperture plate 24. Allowing that it is often favorable to vertically locate the microtiter plate 16 relative to its bottom perimeter, then on the order of 1.6 mm might be allocated for structural rigidity of the microtiter plate mount. Finally, the microtiter plate 16 and the aperture plate 24 must be able to translate in the x, y plane relative to one another, requiring another approximately 1 mm clearance between the microtiter plate mount and the top 34 of the aperture plate 24. In the example provided herein, the vertical spacing between the bottom of the microtiter plate well 8 and the top 34 of the aperture plate 24 was approximately 5.65 mm.

As will be described below, when placement errors are considered, it is advantageous to place the top 34 of the aperture plate 24 as close to the target 8 as the microtiter plate 16 and its mounting system designs will allow. But there is a tradeoff in the spacing between the sources' emitting points and the bottom 32 of the aperture plate 24. From a target irradiance standpoint, the closer the sources 6 can be placed to the aperture plate 24, the better. This guidance is due to the approximately inverse-squared distance correlation between a point source and the object to be irradiated. Since the LEDs 6 are not isotropic point sources, the actual irradiance change with mounting distance will also depend upon the angle between the LEDs' optical axis and the center of the target, and also on the LEDs' viewing angles. But the closer the aperture plate 24 is located relative to the sources 6, the greater the positioning accuracy and precision are required for the aperture plate 24. Hence, there is a tradeoff between irradiance and positioning accuracy and precision.

In the example provided herein, it was chosen to locate the bottom 32 of the aperture plate 24 5.0 mm from the LEDs' emitting points. Since the in-air equivalent target distance from the sources' emitting points was 12.5 mm, then the placement accuracy and precision for equivalent shift of illumination becomes the ratio of the distances, 12.5 mm/5.0 mm=2.5. A misplacement of the target plate well 8, with a perfectly positioned aperture plate 24, by 0.1 mm will be equivalent in effect to a misplacement of the aperture plate 24, with a perfectly positioned target plate well 8, by 0.04 mm.

Preferably, and in the example stated, an illuminated area was defined with a 0.27 mm greater radius than was needed to illuminate the bottom 14 of a perfectly-positioned microtiter plate well 8. It was also ensured that, generally, even if the microtiter plate well 8 were mispositioned by 0.27 mm, no rays 12 could illuminate the outside wall 10 of the target well 8 of the microtiter plate 16 prior to illuminating the target area within the well 8. This error range can be allocated between the positioning of the microtiter plate 16 and the aperture plate 24. The worst case for mispositioning is when the microtiter plate 16 is mispositioned in one direction and the aperture plate 24 is mispositioned in the opposite direction.

Typically, the positioning of the microtiter plate 16 will be more difficult to maintain precisely due to both the microtiter plate tolerances and the fact that the microtiter plate carrier has a substantially larger required range of motion than the aperture plate 24. For example, one might allow a mispositioning range of ±0.145 mm for the microtiter plate 16 and ±0.050 mm for the aperture plate 24. If one were to increase the accuracy and precision of the microtiter plate positioning to, perhaps, a range of ±0.120 mm, then the mispositioning range for the aperture plate 24 could be relaxed to ±0.060 mm. In each case, and in general for the example disclosed herein, the absolute values of the mispositioning ranges, with the range for the aperture plate 24 multiplied by 2.5, should sum to about 0.27 mm. To achieve this kind of accuracy and precision, one assumes a per-microtiter plate positioning calibration of, for example, the corner wells 8 of the plate 16, in order to mitigate some of the microtiter plate's tolerances.

The third consideration about decentration of the centerline of target well 8 relative to the centerline of the illumination LEDs 6 arises due to the fact that the positions of the dual aperture-defining openings 28, 30 per LED 6 in the aperture plate 24 are set for the centered target well 8. As the well 8 is decentered, and the aperture plate 24 is decentered proportionally, the optimum positions of the dual aperture-defining openings 28, 30 per LED 6 shift relative to one another. It is recommended to decide the proportional position of the lower, first opening 28 partially defining an aperture 26 of the aperture plate 24 relative to the position of the decentered well 8. In this way, the nearer edge of the illumination will not encroach into the side 10 of the target microtiter plate well 8. However, the more the microtiter plate well 8 is decentered, and the aperture plate 24 proportionally adjusted to position the first aperture-defining opening 28 correctly, the more incorrect the position of the upper second opening 30 partially defining the aperture 26 will become. This is not as consequential, even if a small amount of light irradiance spills beyond the target well 8 (as the microtiter and aperture plates 16, 24 are moved toward the source 6 being considered), or does not fully illuminate the far end of the well 8 (as the microtiter and aperture plates 16, 24 are moved away from the source 6 being considered). A slight decreasing in the irradiance from the most distant LEDs 6 will not be as significant as the same decrease in the irradiance from the nearest LEDs 6. For example, one might accept that in the case of microtiter plate decentration by half of the field of view of the digital camera 20, a second, top aperture-defining opening 28 of the aperture plate 24 could be mispositioned by as much as 0.16 mm.

As shown in FIG. 28, the four parallel planes referenced previously are shown in translucent gray, with the sources' effective emitting points in plane s at the bottom, the planar bottom and top surfaces 32, 34 of the aperture plate 24 (two planes, a1 and a2) in the center, and the equivalent in-air plane 0 of the object to be illuminated at the top. The center of the object 8 to be illuminated is located at or near the origin of the object coordinate system. The base coordinate system is that of the object plane. The other three coordinate systems are only offset in −z. The x coordinate axes point to the left hand side of the FIG. 28 image, the y coordinate axes point to mostly out of the plane of the FIG. 28 image and also to its lower right, and the z coordinate axis points vertically upward.

Given a desired illumination area and position, the areas and positions of the remaining features can be determined from the x, y position of the source emitting point and the z-axis distance between the sources' emitting points, the aperture plate 24, and the equivalent in-air object plane. In the example shown in FIG. 28, the illumination area is rectangular, such as might be desired for illuminating the field of view of a microscope or digital camera 20. However, it should be realized that the illumination area might be an arbitrarily different shape, such as that of the bottom 14 of a microtiter plate well 8.

Also shown in FIG. 28 are four light rays R1, R2, R3 and R4 selected because they illuminate the four corners of the example rectangular illumination area. Thus, these rays effectively define the desired extent of the illumination on the object 8. In the aperture plate 24, the first and second openings 28, 30 defining an aperture 26 through the thickness of the aperture plate 24 are shown on both the bottom planar surface 32 and the top planar surface 34 of the aperture plate 24. The second aperture opening 30 formed in the top surface 34 of the aperture plate 24 is larger in area than the area of the first aperture opening 28 formed in the bottom surface 32 of the aperture plate 24.

The aperture plate 24 might be hollow, with (relative to the plate's thickness) very thin top and bottom surfaces 34, 32. But more typically for LED illumination, the aperture plate 24 is made as thin as can be reliably produced and used, and permits maintaining a rigid shape. In this latter case, the scaled shapes of each of the second aperture opening 30 and the first aperture opening 28 formed in the top and bottom surfaces 34, 32, respectively, of the aperture plate 24 should be maintained.

It is possible, but complicated, to mold the aperture plate 24 with the passthrough hole connecting the top and bottom aperture openings 30, 28 to match the angles and connections of the four rays' segments connecting the two first and second aperture openings 28, 30. The result would be as if a large number of other, parallel aperture layers were placed in between the two surfaces 32, 34 shown in FIG. 28, each located and scaled in order to place its corners in contact with the four rays R1-R4 shown in FIG. 28. But with using angled illumination, such as might be desired for dark field or fluorescence illumination, such apertures 26 may reflect into the illumination area near-glancing rays 12 that could, without the aperture plate 24, illuminate the object 8 outside the desired illumination area. These reflected rays 12 may degrade the optically flat illumination or detection field sometimes desired for optical imaging.

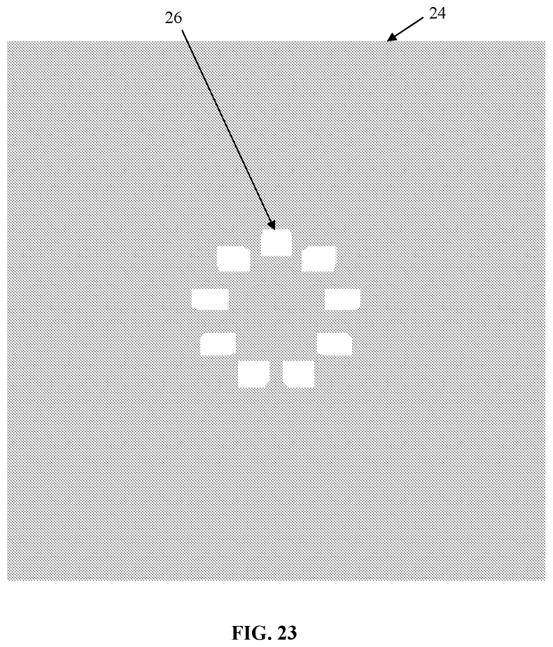

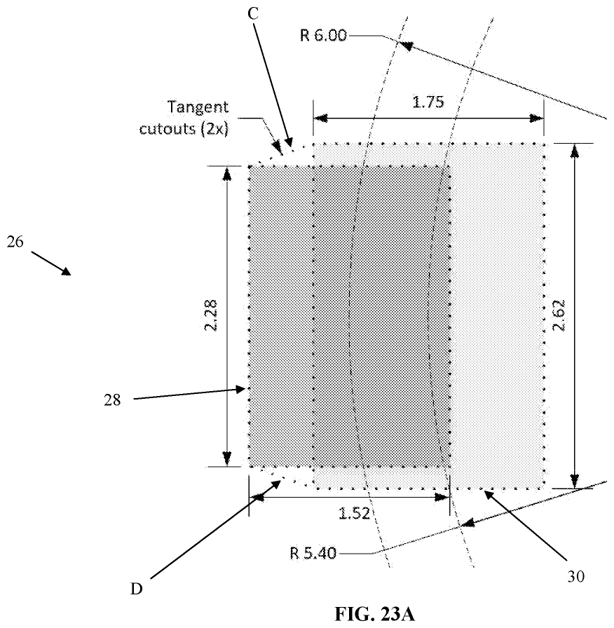

A more producible method of making the aperture plate 24 is to extend each of the first and second openings 28, 30 defining a respective aperture 26 parallelly through the thickness of the aperture plate 24. In this case, the first opening 28 having a relatively smaller area formed in the lower surface 32 of the aperture plate 24 controls transmission of light through the nearer to the source portion of the lower first aperture opening 28, and the second opening 30 having a relatively larger area formed in the upper surface 34 of the aperture plate 24 controls transmission of light through the nearer to the illumination area portion of the upper second aperture opening 30. To facilitate flat-field illumination of the object 8, the compound aperture 26 consisting of two, rectangular in this case, first and second openings 28, 30 each being formed through the thickness of the aperture plate 24 is generally further modified to remove by a straight-line cut (shown at C and D in FIG. 23A) any concavities in the compound aperture 26, but without removing any material from any portion of the compound aperture 26 that is not concave. This compound aperture design also facilitates directing specular reflections away from the object 8 to be illuminated.

If for any reason it is desirable to move the illumination position to a different, nearby position of the object 8 then, ideally, the position of the two first and second aperture openings 28, 30 situated respectively in the planar bottom and top surfaces 32, 34 of the aperture plate 24 and residing respectively in planes a1 and a2 shown in FIG. 28 would be scaled to match the new position of the object illumination. This can be accommodated in cases where the aperture plate 24 is comprised of two relatively thin and independently moveable top and bottom planar sections. According to the more producible method of making the aperture plate 24, moving the aperture plate 24 to accommodate a shift in the desired position of the object illumination results in one or both of the top or bottom openings 30, 28 of the aperture plate 24 being in imperfect position, which may cause either vignetting of the object illumination or illumination of unwanted areas. However, as long as the desired shift of the object illumination is relatively small, where the new area to be illuminated overlaps the centered area by at least ½ about both x and y axes, independently, then shifting the aperture plate 24 in order to reposition the illuminated area will not substantially degrade the illumination quality. According to the position shift limit just described, the area of the new aperture position will overlap the area of the centered one by at least ¼.

When combined with other sources 2 and adding their relevant apertures 26 to the aperture plate 24, a very flat, homogenous illumination or detection area can be formed. The area of the illuminated area can be precisely controlled according to the methods and designs described herein.

In the further examples described herein, image detection using a Mitutoyo 5x Plan Apochromat, long working distance microscope objective, manufactured by Mitutoyo Corporation of Kanagawa, Japan, is used.

For fluorescence imaging of a microtiter plate well 8 with an LED frustum source 2, it is preferred to locate both the source 2 and the detection optics 20 below the microtiter plate 16. Thus, the light source 2 illuminates the sample 22 at acute angles relative to the detection optics 20, and a detection aperture 36 within the aperture plate 24 must be provided.

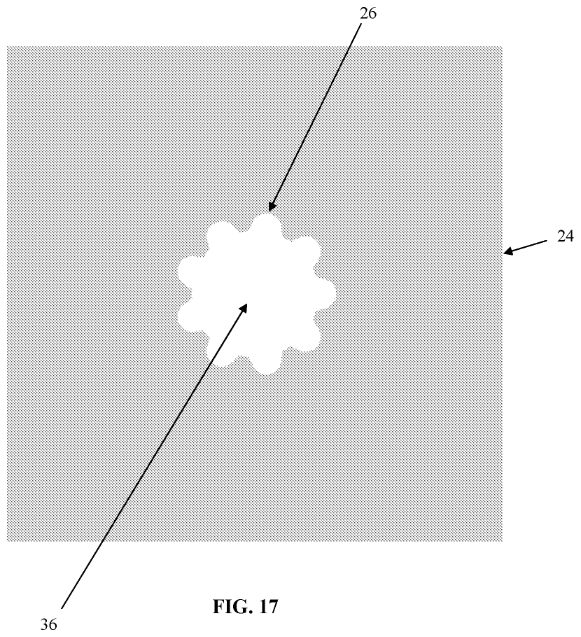

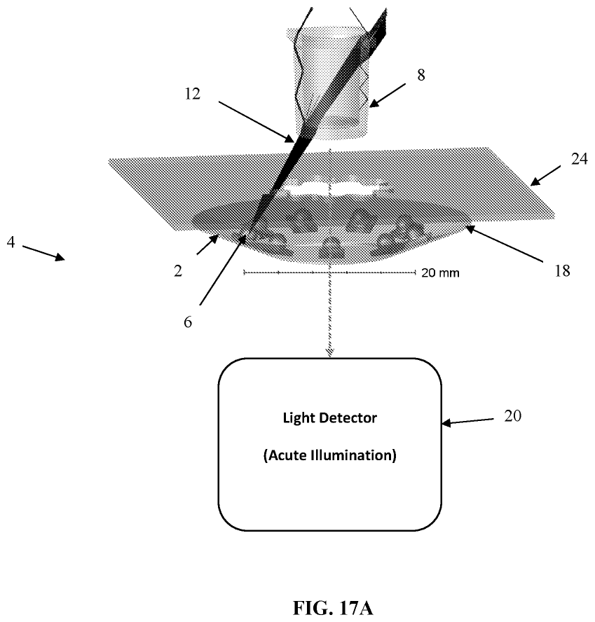

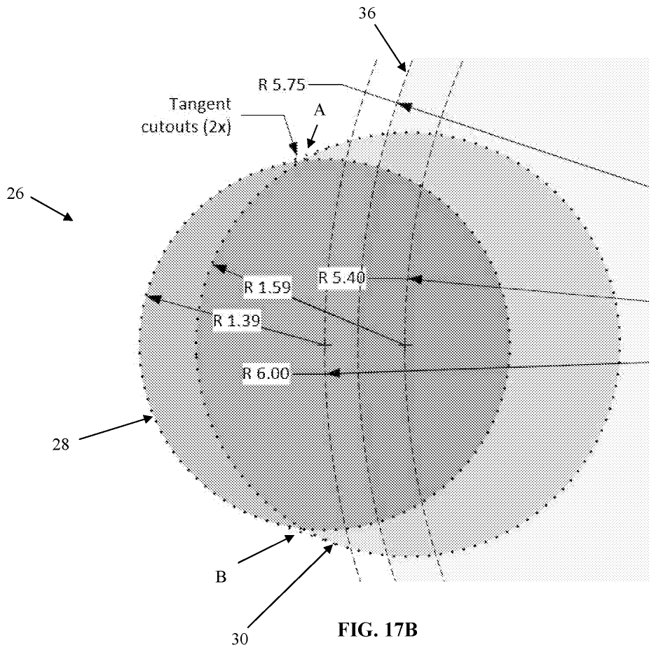

More specifically, to avoid vignetting at the position of the aperture plate 24, a centered hole 36 of radius 5.75 mm is added to the aperture plate 24 shown in FIG. 8. The resulting aperture plate 24 is shown in FIG. 17, with a portion of the central detection opening 36 and a single aperture 26 of the aperture plate 24 shown in FIG. 17B. FIG. 17A illustrates a complete optical system 4, including the aperture plate 24 shown in FIG. 17, the light source 2 and the detection system 20 situated below the light source 2 and with its optical axis coincident with the cylindrical optical axis of the light source 2, and, additionally, a well 8 of a microtiter plate 16. Of course, the frustum-shaped printed circuit board or other fixture 18 on which the LEDs 6 are mounted includes a central opening formed through the thickness thereof and centered on the optical axis of the light source 2 so that fluoresced or reflected light from the irradiated object 8 may pass therethrough and be received by the detection system 20 situated under the light source 2.

Even more specifically, FIG. 17 is another view of the moveable aperture plate 24 formed in accordance with the present invention. In this embodiment, and unlike the aperture plate 24 shown in FIG. 8, the center of the aperture plate 24 now includes an additional, relatively large circular detection aperture 36. This additional circular aperture 36 allows acute illumination and detection from the same side of the well 8, such as imaging the microtiter plate wells 8 from below with an inverted microscope 20. The aperture plate 24 with the apertures 26 formed therein, including the center detection aperture 36, is moved in proportional x, y magnitudes, and in the same x, y direction, as the microtiter plate well 8 is moved in order to obtain images of sections of the assayed well 8. Again, both the well's and the aperture plate's motion are confined, within the limits of the motion system, to the x, y plane. This plane is normal to the optical centerlines of the LED frustum 18, the microscope's objective lens 20 and the centerlines of the microtiter plate wells 8. Using this aperture plate 24, the rays 12 illuminate the outer wall 10 of the microtiter plate 16, and also adjacent wells 8, more strongly than with the aperture plate 24 shown in FIG. 8, but less strongly than they illuminate the target well 8. Nevertheless, illumination of the nearer wall of the microtiter plate 16 before illuminating the sample 22 is still prevented by the aperture plate 24 of the present invention shown in FIG. 17.

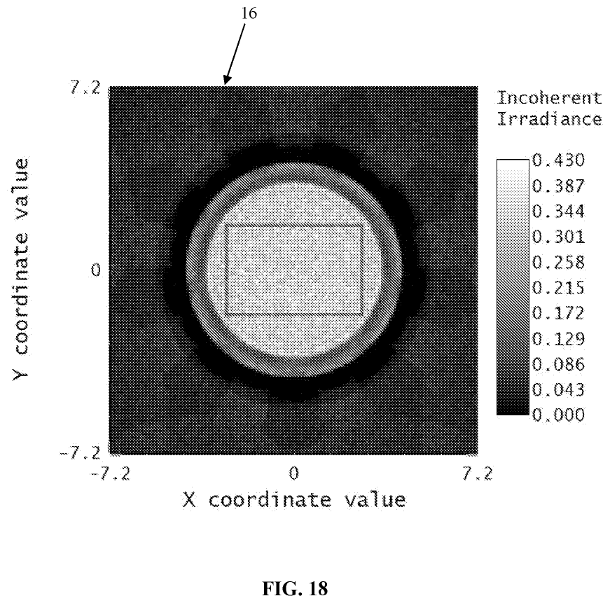

FIG. 18 is a view similar to that shown in FIG. 14, but with the aperture plate 24 shown in FIG. 17 substituted for the aperture plate 24 shown in FIG. 8.

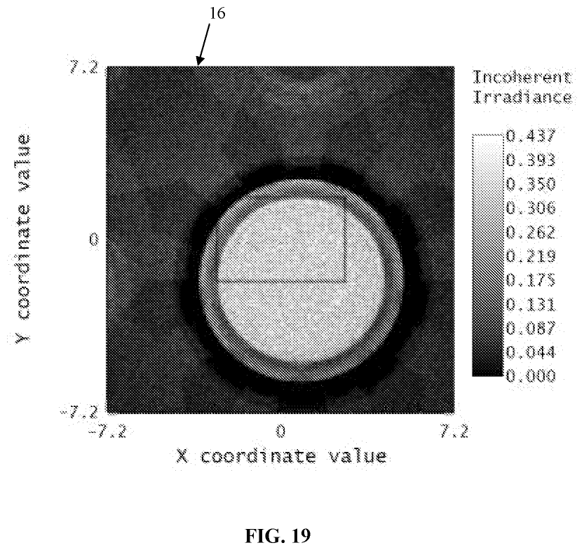

FIG. 19 is a view similar to that of FIG. 15, again with the microtiter plate well 8 offset relative to the LED frustum 18 and the microscope 20. The aperture plate 24 of FIG. 17 is offset proportionally to the plate well 8, and in the same x, y plane and angular direction. The aperture plate 24 also prevents illumination of the microtiter plate's wall 10 by the nearest LEDs 6, thereby preventing light that has first passed through the wall 10 to then illuminate the inside of the plate's well 8.

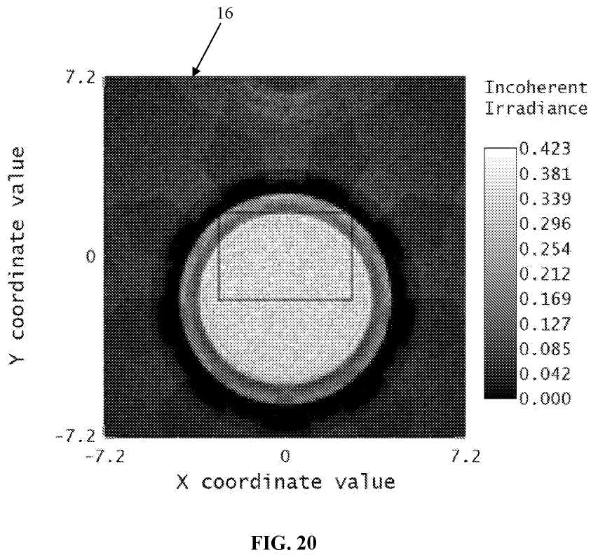

FIG. 20 is a view similar to that of FIG. 16. The aperture plate 24 again prevents illumination of the microtiter plate's wall 10 by any nearby LEDs 6, thereby preventing light that has first passed through the wall 10 to then illuminate the inside of the plate's well 8.

More specifically, the optical images shown in FIGS. 18 through 20 correspond exactly to those shown in FIGS. 14 through 16, respectively, but with the aperture plate 24 shown in FIG. 17 substituted for the aperture plate 24 shown in FIG. 8. Comparing the respective figures, it can be seen that the maximum irradiance is slightly greater in each of the images of FIGS. 18 through 20 compared to the images of FIGS. 14 through 16, respectively. Also, it can be seen that the area of substantial comparative irradiance (relative to the peak irradiance) extends considerably farther away from the center of the well 8 shown in FIGS. 18 through 20 than in FIGS. 14 through 16, respectively. Less easily discernible, but true regardless, the black area around the well 8 shown in FIGS. 18 through 20 shows more hazy structure, especially in the images of FIGS. 19 and 20, again compared with the images of FIGS. 14 through 16, respectively. Nevertheless, the illumination of adjacent wells 8 is substantially mitigated when the optical imaging system 4 uses the aperture plate 24 of the present invention shown in FIG. 17 compared with the results obtained when no aperture plate 24 is used, as is evident from the images of FIGS. 5 through 7, respectively.

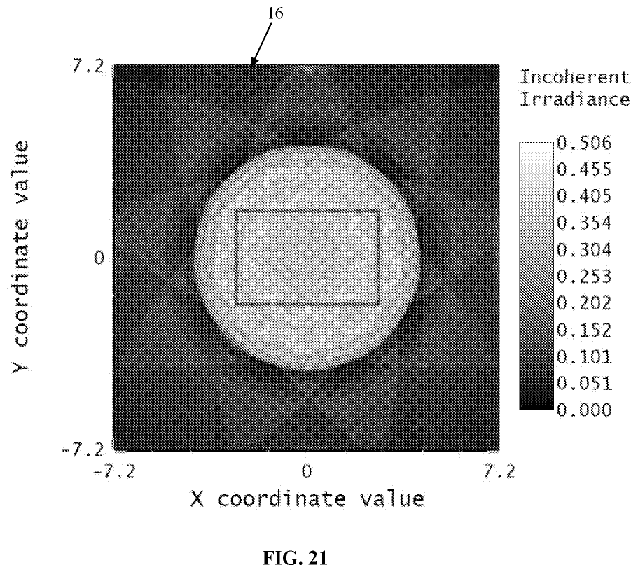

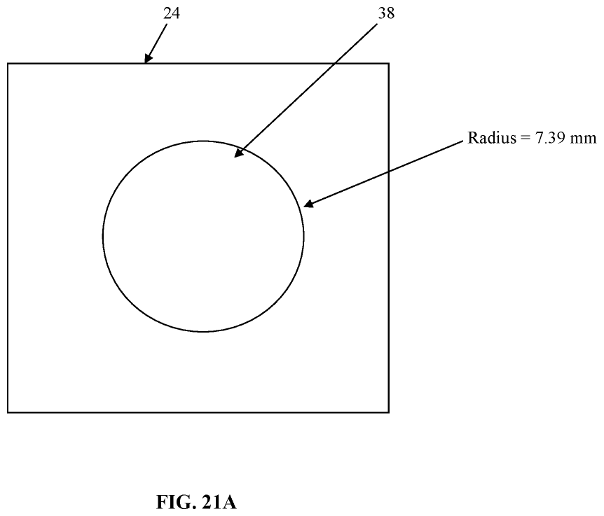

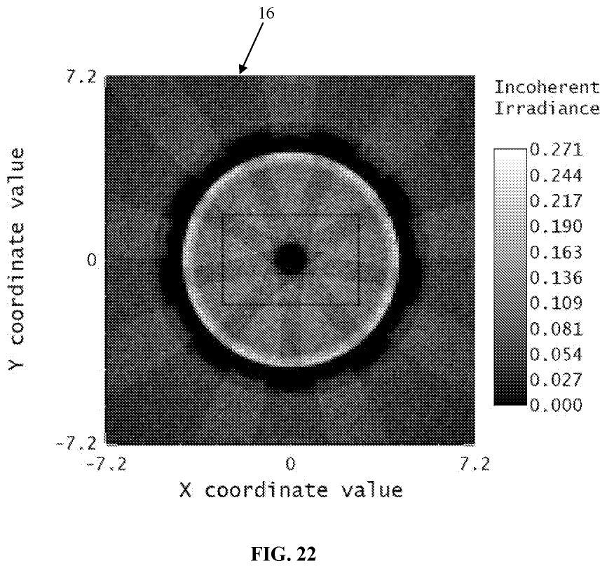

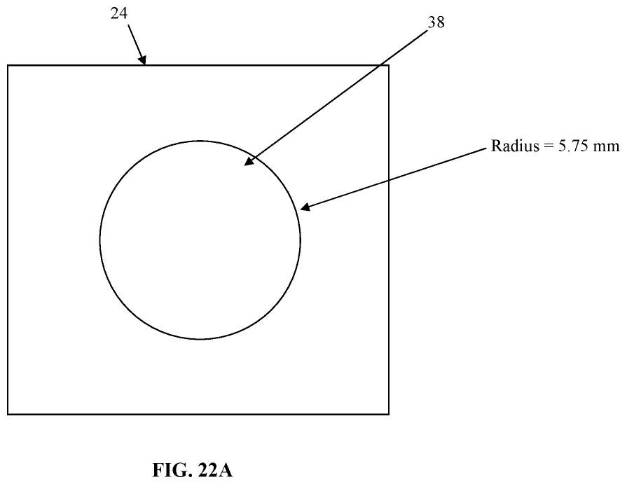

There is an illumination advantage with using in an optical imaging system 4 the aperture plates 24 of the present invention and the particularly-shaped apertures 26 formed therein which are described herein, relative to aperture plates 24 having single circular apertures. Two aperture plates 24 having single circular apertures 38 are explicitly considered, and are shown by way of example in FIGS. 21A and 22A. Each of these two aperture plates 24 considered has the same position, thickness and horizontal extent as those shown in FIGS. 8, 9 and 17.

As shown in FIG. 21A, the first aperture plate 24 includes a single circular aperture 38 having a radius of 7.39 mm formed through the thickness of the plate 24. This radius value was considered because it has the same outermost radial extent of the aperture-defining openings 28, 30 and apertures 26 formed in the aperture plates 24 shown in FIGS. 8 and 17. FIG. 21 is a view similar to that shown in FIGS. 14 and 18, but generated using an aperture plate 24 having a single circular aperture 38 whose radius matches the outermost points of the outer holes 28 in the aperture plates 24 shown in FIGS. 8 and 17, as described above. As can be seen from FIG. 21, the irradiance of adjacent wells 8 is substantially reduced compared to the apertureless irradiance condition depicted in FIG. 5. Nevertheless, as in the image shown in FIG. 5 and unlike the images shown in FIGS. 14 and 18 generated when the aperture plate 24 of the present invention is used in an optical imaging system 4, there is substantial structure in the irradiance pattern, problematic for measurements requiring precise quantitative or within-image locational analysis.

FIG. 22 is a view similar to that of FIG. 21, but with the aperture plate 24 formed with a single circular aperture 38 having a radius that matches the radius of the centered, large aperture hole 38 in the aperture plate shown in FIG. 17. If the circular aperture's radius is reduced to that required for a non-vignetted image using the Mitutoyo 5x objective described previously, then the resulting irradiance pattern becomes substantially structured. This result is shown in FIG. 22, where the aperture's radius was 5.75 mm.

Circular apertures 38 with radii in between those considered for the aperture plates 24 shown in FIGS. 21A and 22A and their resulting irradiance images shown in FIGS. 21 and 22, respectively, will exhibit irradiance patterns that combine the features of the two cases shown in these figures. For the aperture plates 24 to provide both a very flat optical field and substantially reduced illumination of adjacent wells 8, it is better that the aperture plate 24 incorporate features matching the number of LEDs 6 employed, as the aperture plates of FIGS. 8 and 17 show. But as the number of LEDs 6 is increased substantially, the usefulness of the aperture plates 24 described herein diminishes to the point of ineffectiveness. An aperture plate 24 comprised of a single aperture 38 will be just as effective in such a situation.

It may be useful to illuminate a rectangular area of an object, such as might be desired for obtaining images from a rectangular well 8, cuvette or the like containing a liquid sample 22, where again there is a need to eliminate any light rays 12 that pass through a side wall 10 of the sample container 8 from then irradiating the sample 22. Also, the rectangular limitation may be useful for situations where the sample 22 is sensitive to photobleaching, and a number of rectangular images are to be obtained, such as of areas of a microscope slide.

The same design criteria apply for configuring an aperture plate 24 with one or more series of spaced apart rectangular first and second aperture-defining openings 28, 30 as for the aperture plate 24 having the radially inner and outer series of circular holes 28, 30 described previously and shown in FIGS. 8 and 9 holes but with the added requirements that all rectangle openings 28, 30 should be oriented angularly parallel to the desired illumination rectangle of the object 8. An example of such an aperture plate 24 formed in accordance with the present invention to illuminate an area 8.5% larger than the field of view of the microscope, that is, of 5.70 mm×3.80 mm, would include a first set of radially outer, spaced apart, smaller rectangular openings 28 which are preferably 2.28 mm×1.52 mm in size, and a second set of radially inner, spaced apart larger rectangular openings 30 which are preferably 2.62 mm×1.75 mm in size and which overlap corresponding smaller openings 28 of the first series of openings 28. The ratios of 0.40 and 0.46, respectively, are preserved in this example, as well. The centers of the radially outer and radially inner rectangular holes 28, 30 are located on the same bolt circles as the centers of the radially outer and radially inner circular holes 28, 30 in the aperture plate 24 of the present invention shown in FIG. 8 of the drawings.

An additional preferred form of the rectangular openings 28, 30 of the plate 24 is that the vertices of the relatively smaller rectangular openings 28 generally should be connected to their corresponding vertices on the relatively larger rectangular openings 30 wherever this connecting line segment falls outside of the area of both rectangular openings 28, 30. In general, the perimeters of each pair of overlapping radially outer and radially inner rectangular holes or openings 28, 30 so connected form irregular hexagonal apertures 26. If this is not done, and there are substantial concavities in the perimeter of the combined rectangular holes 28, 30, then the corners of the illumination area may be noticeably vignetted. The resulting aperture plate 24 with such compound apertures 26 is shown in FIGS. 23 and 23A. More specifically, FIG. 23 is a view of an aperture plate 24 formed in accordance with the present invention which is similar to that depicted in FIG. 8, but with combined overlapping rectangular holes 28, 30 forming apertures 26 configured to illuminate an area slightly greater than the detectable field that has been considered earlier and shown in FIGS. 5-7, 14-16, and 18-22. FIG. 23A illustrates as an example the formation of an aperture 26 in the aperture plate 24 shown in FIG. 17 from two overlapping first and second rectangular openings 28, 30 formed respectively in the bottom and top surfaces 32, 34 of the aperture plate 24 and particularly arranged with respect to one another. It should be noted that each aperture 26 may be formed with tangential cutouts C and D extending between the radially outermost corners of the first (smaller in area than the second opening 30) rectangular opening 28 and the second (larger in area than the first opening 28) rectangular opening 30, the corners of each rectangular first opening 28 and rectangular second opening 30 being formed by adjoining sides thereof defining each opening's rectangular shape. The aperture 26 depicted in FIG. 23A corresponds to the top aperture of the aperture plate 24 shown in FIG. 23.

Also like the aperture plate 24 of FIG. 8, the aperture plate 24 of FIG. 23 should be used with obtuse illumination, that is, with the detection optics 20 on the opposite side of the object 8 as the light source 2, such as with a conventional microscope configuration.

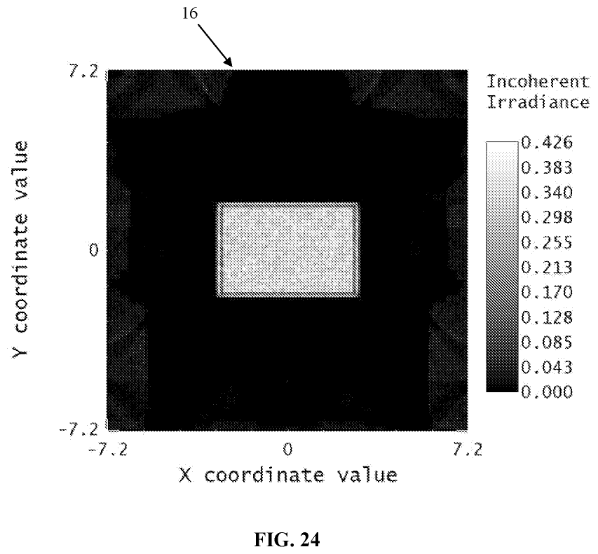

FIG. 24 is a view similar to that shown in FIG. 14 but, instead of the aperture plate 24 shown in FIG. 8 being used to generate the image, the aperture plate 24 shown in FIG. 23 is used. More specifically, FIG. 24 shows the result being a flat irradiance field, with little illumination outside of the desired, slightly larger than detectable, field of view. Although the application of this aperture plate 24 shown in FIG. 23 will generally be better suited for rectangular wells 8 or rectangular imaging areas, the same centered microtiter plate well 8 is considered here for consistency.

This aperture plate 24, configured with sets of rectangular aperture-defining holes 28, 30, as shown in FIG. 23, most likely will not work as well for imaging portions of microtiter plate wells 8, such as shown in FIGS. 15, 16, 19 and 20, as the other embodiments of the aperture plate 24 shown in FIGS. 8, 9 and 17. If the aperture plate 24 of FIG. 23 is moved proportionately with the microtiter plate well 8, then it may be possible for some illumination to now enter the well's liquid contents 22 through the well's cylindrical or slightly conical side walls 10, leading to unwanted fine structure in the irradiation pattern. However, if the aperture plate 24 shown in FIG. 23 remains stationary in the case of multiple, rectangular imaging areas, then the desired area is not fully illuminated; rather, the area to be imaged is moved relative to the illumination and the microscope's field of view.

Thus, the rectangular aperture configuration of the aperture plate 24 shown in FIG. 23 generally is better suited for applications where the aperture plate 24 does not move, and all motion is of the sample or target object 8. Again, the aperture plate 24 with rectangular aperture-defining holes 28, 30, such as shown in FIG. 23, and an optical imaging system 4 employing such an aperture plate 24, work well with rectangular wells 8 and microscope slides and other test slides. Nevertheless, the aperture plate 24 with rectangular aperture-defining holes 28, 30 shown in FIG. 23 can work well in a microtiter plate well imaging application if the field of view of any one image is small relative to the area of the well 8. In this situation, the entire area of the well 8 can be covered by many images and, at worst, only small portions of the well's wall 10 are illuminated in an image.

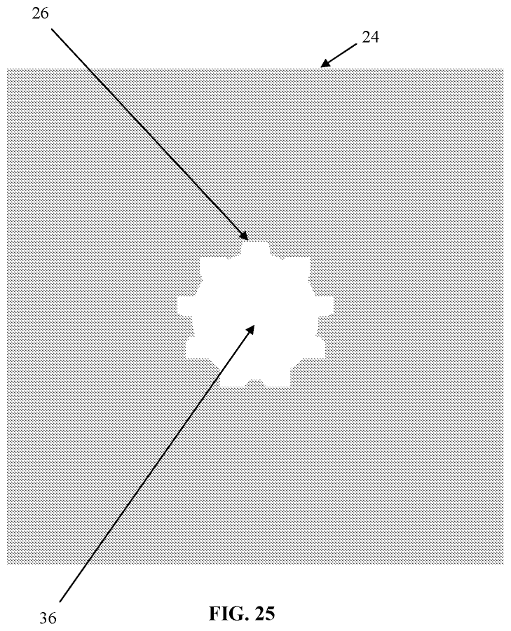

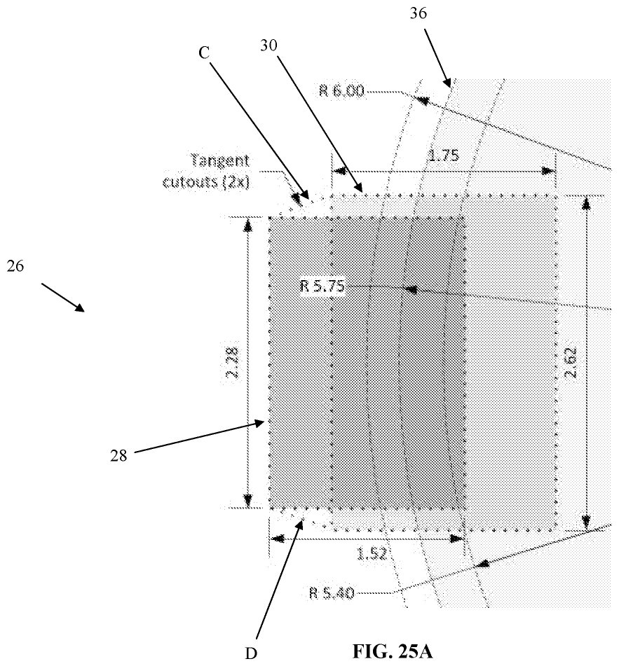

FIG. 25 is a view of an aperture plate 24 similar to that depicted in FIG. 23 but, like the aperture plate 24 shown in FIG. 17, with a centered circular hole 36 permitting illumination angles acute relative to the detection optics 20. More specifically, FIG. 25 shows the aperture plate 24 of FIG. 23 having composite, somewhat hexagonal, spaced apart apertures 26 formed through the thickness of the aperture plate 24, where each aperture 26 is formed from overlapping rectangular first and second openings 28, 30, with, also added, the same central circular aperture 36 applied in the aperture plate 24 shown in FIG. 17. A portion of the central opening 36 and a single aperture 26 of the aperture plate 24 is shown in FIG. 25A. The resulting apertures' irregular perimeter still works well for providing a flat irradiance field for the desired field of view. Like the irradiance images shown in FIGS. 18 through 20, substantially more nearby areas of the well 8 or other target object are illuminated, but still much less than would have been illuminated with no aperture plate 24 present in the optical imaging system.

With its central hole 38, the aperture plate 24 shown in FIG. 25 can be used with acute illumination, that is, with the detection optics 20 on the same side of the object 8 as the light source 2, such as with an inverted microscope configuration.

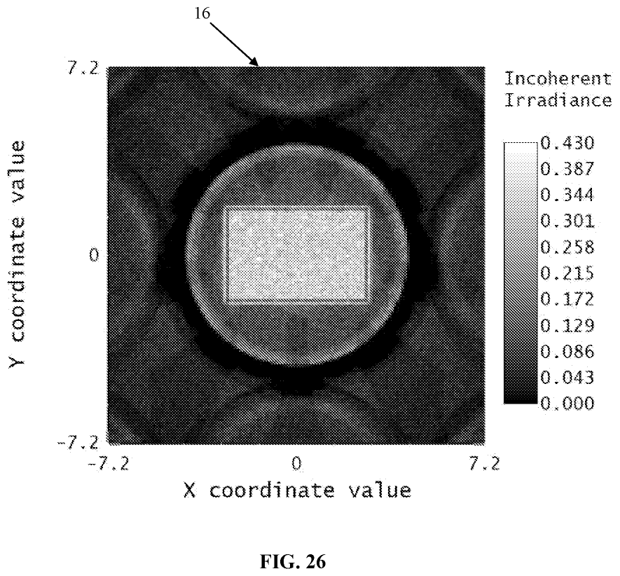

FIG. 26 is a view similar to that shown in FIG. 24 but, instead of using the aperture plate 24 shown in FIG. 23, the image of FIG. 26 was generated using the aperture plate 24 shown in FIG. 25.

The aperture plate 24 of the present invention, with its particularly-shaped apertures 26, and an optical imaging system 4 employing such an aperture plate 24, may be used to illuminate a defined area of an object, such as the wells 8 of a microtiter plate 16, a cuvette or other sample holding container, or a microscope slide or other test slide having a sample deposited thereon or held therein, resulting in more accurate analyses and measurements performed on the sample held by the container or deposited on the slide. It is also envisioned that an optical imaging system 4 incorporating such an aperture plate 24 may be used for the inspection of discrete parts and components in an inspection system for the controlled illumination of regions of such parts and components. The aperture plate 24 of the present invention, when used in an optical imaging system 4, can control the obscuration and/or permit the transmission of rays of light emitted by a light source 2 of the imaging system 4.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

1. An optical imaging system, which comprises:
a light source, the light source including a plurality of energizable light emitting devices which, when energized, emit light that is directed toward an object to be illuminated;
a light detector positioned to be in optical communication with the object illuminated by the light source; and
an aperture plate, the aperture plate being positioned relative to the light source to block a first portion of the light emitted by the light source and to allow a second portion of the light emitted by the light source to pass therethrough to illuminate a pre-defined area of the object;
wherein the aperture plate includes a plurality of spaced apart apertures formed through the thickness thereof, each aperture of the plurality of apertures corresponding to a respective light emitting device of the plurality of light emitting devices; and
wherein each aperture of the plurality of apertures of the aperture plate is defined by a first opening formed in the thickness of the aperture plate and a second opening formed in the thickness of the aperture plate, the second opening partially overlapping the first opening and being partially offset from the first opening, the first opening having at least one first dimension, and the second opening having at least one second dimension, the at least one second dimension of the second opening being different from the at least one first dimension of the first opening.

2. An optical imaging system as defined by claim 1,
wherein the first opening of each aperture of the plurality of apertures formed in the aperture plate resides in a circle having a first bolt radius;
wherein the second opening of each aperture of the plurality of apertures formed in the aperture plate resides in a circle having a second bolt radius;
wherein each light emitting device of the plurality of spaced apart, energizable, light emitting devices is defined with an emitting point;
wherein the light emitting devices are arranged such that the emitting point of each light emitting device resides in a circle having a third bolt radius; and
wherein each of the first bolt radius of the circle of first openings and the second bolt radius of the circle of second openings is proportional to the third bolt radius of the circle in which the emitting points of the light emitting devices reside.

3. An optical imaging system as defined by claim 2, wherein the first bolt radius and the third bolt circle have a 0.40 ratio.

4. An optical imaging system as defined by claim 1, which further comprises:
a printed circuit board, the plurality of light emitting devices being mounted on the printed circuit board.

5. An optical imaging system as defined by claim 4, the printed circuit board having the shape of a frustum of a right circular cone.

6. An optical imaging system as defined by claim 1, wherein each light emitting device of the plurality of light emitting devices is a light emitting diode.

7. An optical imaging system as defined by claim 6, wherein each light emitting diode has an eighty degree (80°) viewing angle.

8. An optical imaging system as defined by claim 2, wherein the aperture plate includes a central detection opening formed through the thickness thereof, the central detection opening being disposed concentrically to and within the circle of first openings partially defining respective apertures formed in the aperture plate, the central detection opening having a radius which is less than the first bolt radius of the circle of first openings.

9. An optical imaging system as defined by claim 1, wherein each first opening at least partially defines a respective aperture formed in the aperture plate and is formed in the shape of a circle having a predetermined first radius;
wherein each second opening at least partially defines a respective aperture formed in the aperture plate and is formed in the shape of a circle having a predetermined second radius; and
wherein the first radius of the circle shape of each of the first openings is less than the second radius of the circle shape of each of the second openings.

10. An optical imaging system as defined by claim 9, wherein each of the overlapping first openings and second openings, formed in the shape of circles, has a perimeter; and
wherein the aperture plate has further formed therein a first cutout and a second cutout associated with each aperture, the first cutouts and second cutouts joining and extending tangentially to the perimeters of respective overlapping first and second openings.

11. An optical imaging system as defined by claim 1, wherein each first opening at least partially defines a respective aperture formed in the aperture plate and is formed in the shape of a rectangle having adjoining sides and defining a first rectangular area;
wherein each second opening at least partially defines a respective aperture formed in the aperture plate and is formed in the shape of a rectangle having adjoining sides and defining a second rectangular area; and
wherein the first rectangular area of the rectangle shape of each of the first openings is less than the second rectangular area of the rectangle shape of each of the second openings.

12. An optical imaging system as defined by claim 11, wherein each of the overlapping first openings and second openings, formed in the shape of rectangles, includes a first corner and a second corner, each of the first corner and the second corner of each first opening being defined by the adjoining sides of each first opening, each of the first corner and the second corner of each second opening being defined by the adjoining sides of each second opening; and
wherein the aperture plate has further formed therein a first cutout and a second cutout associated with each aperture, the first cutout joining and extending between the first corner of a first opening and the first corner of a second opening defining a respective aperture, the second cutout joining and extending between the second corner of the first opening and the second corner of the second opening defining a respective aperture.

13. An aperture plate for use in an optical imaging system, the optical imaging system having a light source, the light source including a plurality of energizable light emitting devices which, when energized, emit light that is directed toward an object to be illuminated, and further having a light detector positioned to be in optical communication with the object illuminated by the light source, the aperture plate comprising:
a main body; and
a plurality of spaced apart apertures formed through the thickness of the main body, each aperture of the plurality of apertures of the aperture plate being defined by a first opening formed in the thickness of the main body of the aperture plate and a second opening formed in the thickness of the main body of the aperture plate, the second opening partially overlapping the first opening and being partially offset from the first opening, the first opening having at least one first dimension, and the second opening having at least one second dimension, the at least one second dimension of the second opening being different from the at least one first dimension of the first opening, the aperture plate being positionable in the optical imaging system and relative to the light source thereof to block a first portion of the light emitted by the light source and to allow a second portion of the light emitted by the light source to pass therethrough to illuminate a pre-defined area of the object.

14. An aperture plate as defined by claim 13, wherein the first opening of each aperture of the plurality of apertures formed in the main body of the aperture plate resides in a circle having a first bolt radius;
wherein the second opening of each aperture of the plurality of apertures formed in the main body of the aperture plate resides in a circle having a second bolt radius;
wherein the first bolt radius of the circle of first openings is different from the second bolt radius of the circle of second openings.

15. An aperture plate as defined by claim 14, wherein the main body of the aperture plate includes a central detection opening formed through the thickness thereof, the central detection opening being disposed concentrically to and within the circle of first openings partially defining respective apertures formed in the main body of the aperture plate, the central detection opening having a radius which is less than the first bolt radius of the circle of first openings.

16. A method of illuminating a defined area of an object, which comprises the steps of:
energizing at least one light emitting device of a plurality of spaced apart light emitting devices of a light source in an optical imaging system, the at least one energized light emitting device emitting light that is directed toward the object to be illuminated;
blocking a first portion of the light emitted by the at least one light emitting device of the light source by an aperture plate positioned between the light source and the object to be illuminated; and
passing a second portion of the light through at least one aperture of a plurality of apertures formed through the thickness of the aperture plate, each aperture of the aperture plate being defined by a first opening formed in the thickness of the aperture plate and a second opening formed in the thickness of the aperture plate, the second opening partially overlapping the first opening and being partially offset from the first opening, the first opening having at least one first dimension, and the second opening having at least one second dimension, wherein the at least one second dimension of the second opening is different from the at least one first dimension of the first opening, the second portion of the light emitted by the at least one light emitting device and passing through the at least one aperture of the aperture plate impinging on the object to be illuminated and illuminating the object over a defined area of the object.

17. A method of illuminating a defined area of an object as defined by claim 16, wherein the first opening of each aperture of the plurality of apertures formed in the aperture plate resides in a circle having a first bolt radius;
wherein the second opening of each aperture of the plurality of apertures formed in the main body of the aperture plate resides in a circle having a second bolt radius;
wherein the first bolt radius of the circle of first openings is different from the second bolt radius of the circle of second openings.

18. A method of illuminating a defined area of an object as defined by claim 17,
wherein the first bolt radius of the circle of first openings partially defining respective apertures formed in the aperture plate is about 6.00 millimeters;
wherein each of the first openings partially defining respective apertures formed in the aperture plate is circular and has a radius of about 1.39 millimeters;
wherein the second bolt radius of the circle of second openings partially defining respective apertures formed in the aperture plate is about 5.40 millimeters; and
wherein each of the second openings partially defining respective apertures formed in the aperture plate is circular and has a radius of about 1.59 millimeters.

19. A method of illuminating a defined area of an object as defined by claim 17, wherein the aperture plate includes a central detection opening formed through the thickness thereof, the central detection opening being disposed concentrically to and within the circle of first openings partially defining respective apertures formed in the aperture plate, the central detection opening having a radius which is less than the first bolt radius of the circle of first openings.

20. A method of illuminating a defined area of an object as defined by claim 18, wherein the aperture plate includes a central detection opening formed through the thickness thereof, the central detection opening being disposed concentrically to and within the circle of first openings partially defining respective apertures formed in the aperture plate, the central detection opening having a radius which is less than the first bolt radius of the circle of first openings.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)
